(19) United States
(12) Patent Application Publication
(10) Pub. No.: US 2014/0373947 A1
(43) Pub. Date: Dec. 25, 2014

(54) GAS FLOW SYSTEM FOR A MACHINE

(71) Applicant: Caterpillar Inc., Peoria, IL (US)

(72) Inventors: Haiping Hong, Peoria, IL (US); Chris J. Scolton, Edelstein, IL (US); Tyler J. Williams, Peoria, IL (US)

(73) Assignee: Caterpillar Inc., Peoria, IL (US)

(21) Appl. No.: 14/189,137

(22) Filed: Feb. 25, 2014

Related U.S. Application Data
(60) Provisional application No. 61/837,918, filed on Jun. 21, 2013.

(51) Int. Cl. F17D 5/00

(52) U.S. Cl. CPC F17D 5/00
USPC 137/544

(57) ABSTRACT

A gas flow system for a machine. The gas flow system can include an air filtration system which can include a debris chamber. The gas flow system can also include a first conduit, a second conduit, and one or more tabs. The first conduit can extend from an upstream end to a downstream end. The upstream end of the first conduit can be connected in fluid communication with the debris chamber, and the downstream end of the first conduit can be positioned within the second conduit. The one or more tabs can be positioned within the second conduit adjacent to the downstream end of the first conduit. The second conduit can include one or more of a decreasing diameter and a substantially consistent diameter adjacent to and downstream of the downstream end of the first conduit.

### RELATED APPLICATION

This application is based upon and claims the benefit of priority from U.S. Provisional Application No. 61/837,918 by Haiping Hong et al., filed Jun. 21, 2013, the contents of which are expressly incorporated herein by reference.

### TECHNICAL FIELD

The present disclosure relates to a gas flow system, and more particularly, to a gas flow system for a machine.

### BACKGROUND

Some components of machines can be damaged if dust or debris come in contact with or enter the component. For example, if dust enters an intake manifold of an engine, it may damage the combustion cylinders. Often machines working in dusty, or debris filled environments are equipped with air filtration systems. The air filtration systems protect sensitive components by removing dust and/or debris from air entering or having contact with the components.

Some filtration systems trap larger debris in a debris chamber and then filter the remaining air. The chamber may be fluidly connected with an air outlet through an exhaust pipe which may draw the debris out of the chamber and expel it through the air outlet into the air surrounding the machine. U.S. Pat. No. 7,004,987 issued to Pikesh et al., discloses a pre-cleaner for an air induction system of an internal combustion engine including a housing enclosing an upper chamber and an aspirator port chamber. The upper chamber contains a plurality of particulate separator tubes arranged in a predetermined array. Each of the tubes includes a particulate outlet through which particles removed from air flowing through the tube en route to the engine are discharged. The aspirator port chamber is located beneath, and is upwardly open to, the particulate outlets and includes an upwardly facing particle collecting surface located directly beneath the particulate outlets. Particles can fall from the tubes into the aspirator port chamber and onto the upwardly facing particle collecting surface. The housing includes a generally horizontally facing aspirator port in the aspirator port chamber adjacent to and facing the particle collecting surface. The housing also includes an element disposed for connecting the aspirator port to an exhaust tract of the internal combustion engine such that the exhaust flow through the exhaust tract will generate a suction condition in the aspirator port when the engine is operated. The particle collecting surface is positioned and oriented such that the suction generated by the exhaust flow during the operation of the engine will draw a flow of air from the upper chamber across the particle collecting surface such that particles collected on the surface will be drawn in an at least generally horizontal direction into the aspirator port.

In some operating conditions, airflow created through a pre-cleaner by a flow of gas through an exhaust pipe and an air outlet, to draw debris out of a debris chamber, through a debris conduit, and through the air outlet may not be sufficient to remove enough debris from the chamber.

### SUMMARY

One aspect of the present disclosure is directed to a gas flow system for a machine. The gas flow system can include an air filtration system which can include a debris chamber. The gas flow system can also include a first conduit, a second conduit, and one or more tabs. The first conduit can extend from an upstream end to a downstream end. The upstream end of the first conduit can be connected in fluid communication with the debris chamber, and the downstream end of the first conduit can be positioned within the second conduit. The one or more tabs can be positioned within the second conduit adjacent to the downstream end of the first conduit. The second conduit can include one or more of a decreasing diameter and a substantially consistent diameter adjacent to and downstream of the downstream end of the first conduit.

Another aspect of the present disclosure is directed to a gas flow system for a machine. The gas flow system can include a substantially enclosed compartment which can include a hollow interior. The gas flow system can also include a gas inlet which can be connected in fluid communication with the hollow interior of the compartment. The gas flow system can additionally include a gas outlet. The gas outlet can include a hollow interior which can extend from an upstream end to a downstream end of the gas outlet. The upstream end of the gas outlet can include an opening fluidly connecting the hollow interior of the compartment with the hollow interior of the gas outlet. The gas flow system can further include a conduit extending from an upstream end to a downstream end. The downstream end of the conduit can be in fluid communication with the hollow interior of the compartment and the hollow interior of the gas outlet. The gas flow system can additionally include one or more tabs which can be positioned adjacent to the downstream end of the conduit and in fluid communication with the interior of the compartment and the interior of the gas outlet. The downstream end of the conduit can be positioned at one of a plurality of positions along an axial length which can extend from the upstream end of the gas outlet into the hollow interior of the gas outlet.

Yet another aspect of the present disclosure is directed to a gas flow system for a machine. The gas flow system can include an air filtration system which can include a debris chamber. The gas flow system can additionally include an exhaust system which can include an exhaust conduit extending from an upstream end to a downstream end. The gas flow system can further include a debris removal system and a compartment cooling system. The debris removal system can include a debris conduit, the exhaust conduit, and one or more tabs. The compartment cooling system can include a substantially enclosed compartment including a hollow interior, a gas inlet connected in fluid communication with the hollow interior of the compartment, a gas outlet, the exhaust conduit, and one or more tabs. The debris conduit can extend from an upstream end to a downstream end, the upstream end of the debris conduit can be connected in fluid communication with the debris chamber, and the downstream end of the debris conduit positioned within the exhaust conduit. The one or more tabs of the debris removal system positioned within the exhaust conduit adjacent to the downstream end of the debris conduit. The gas outlet can include a hollow interior which can extend from an upstream end to a downstream end of the gas outlet. The upstream end of the gas outlet can include an opening fluidly connecting the hollow interior of the compartment with the hollow interior of the gas outlet. The downstream end of the exhaust conduit can be positioned in fluid communication with the hollow interior of the compartment and the hollow interior of the gas outlet. The one or more tabs of the compartment cooling system can be positioned adjacent to the downstream end of the exhaust conduit and in fluid communication with the interior of the compartment and the interior of the gas outlet.

### BRIEF DESCRIPTION OF THE DRAWINGS

FIG. 1 depicts an exemplary machine including an exemplary gas flow system.

FIG. 2 schematically depicts an exemplary gas flow system according to one embodiment.

FIG. 3 schematically depicts an exemplary gas flow system according to another embodiment.

FIG. 4 is an isometric cross section of a portion of an exemplary debris conduit disposed in an exemplary debris removal section of an exemplary exhaust conduit according to one embodiment.

FIG. 5 is an isometric cross section of a portion of an exemplary debris conduit disposed in an exemplary debris removal section of an exemplary exhaust conduit according to another embodiment.

FIG. 6 depicts an embodiment of an exemplary tab.

FIG. 7 depicts another embodiment of an exemplary tab.

FIG. 8 depicts another embodiment of an exemplary tab.

FIG. 9 is a cross section depicting an exemplary mixing and vortex generation zone and illustrating a portion of an exemplary debris conduit disposed in an exemplary debris removal section of an exemplary exhaust conduit according to one embodiment.

FIG. 10 is a cross section depicting an exemplary mixing and vortex generation zone and illustrating a portion of an exemplary debris conduit disposed in an exemplary debris removal section of an exemplary exhaust conduit according to another embodiment.

FIG. 11 is an isometric cross section of a portion of an exemplary exhaust conduit and an exemplary gas outlet.

FIG. 12 depicts an embodiment of an exemplary tab.

FIG. 13 depicts another embodiment of an exemplary tab.

FIG. 14 depicts another embodiment of an exemplary tab.

FIG. 15 depicts another embodiment of an exemplary tab.

FIG. 16 depicts a partial isometric view of a second or downstream end of an exemplary exhaust conduit illustrating another embodiment of an exemplary tab.

FIG. 17 is a cross section depicting an exemplary mixing and vortex generation zone and illustrating a portion of an exemplary exhaust conduit and an exemplary gas outlet.

### DETAILED DESCRIPTION

Reference will now be made in detail to specific embodiments or features, examples of which are illustrated in the accompanying drawings. Generally, corresponding or similar reference numbers will be used, when possible, throughout the drawings to refer to the same or corresponding parts. Elements in schematics, included in the drawings, and described herein, may not be drawn with dimensions or to any realistic scale, but may rather be drawn to illustrate different aspects of the disclosure.

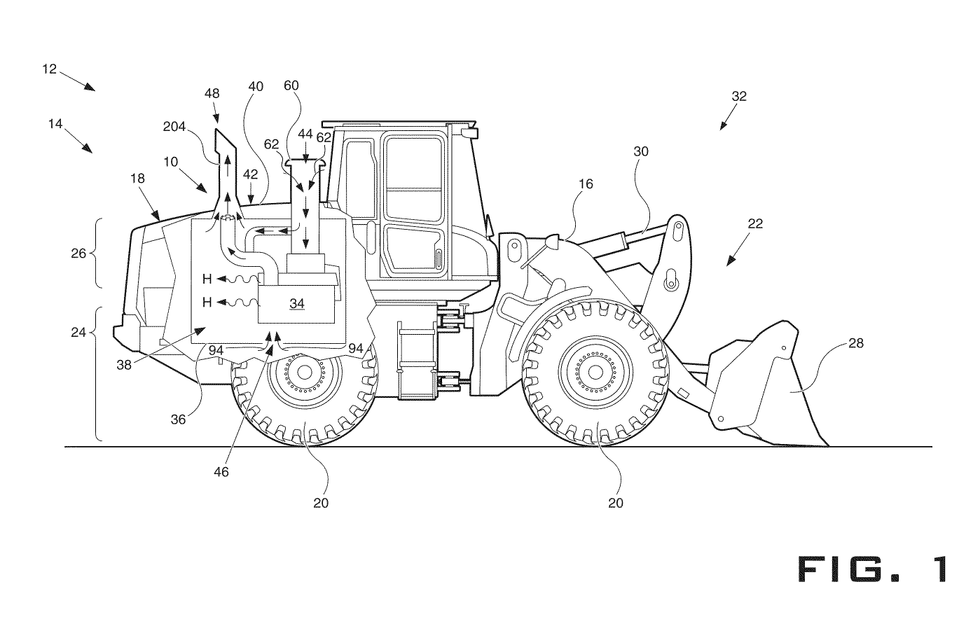

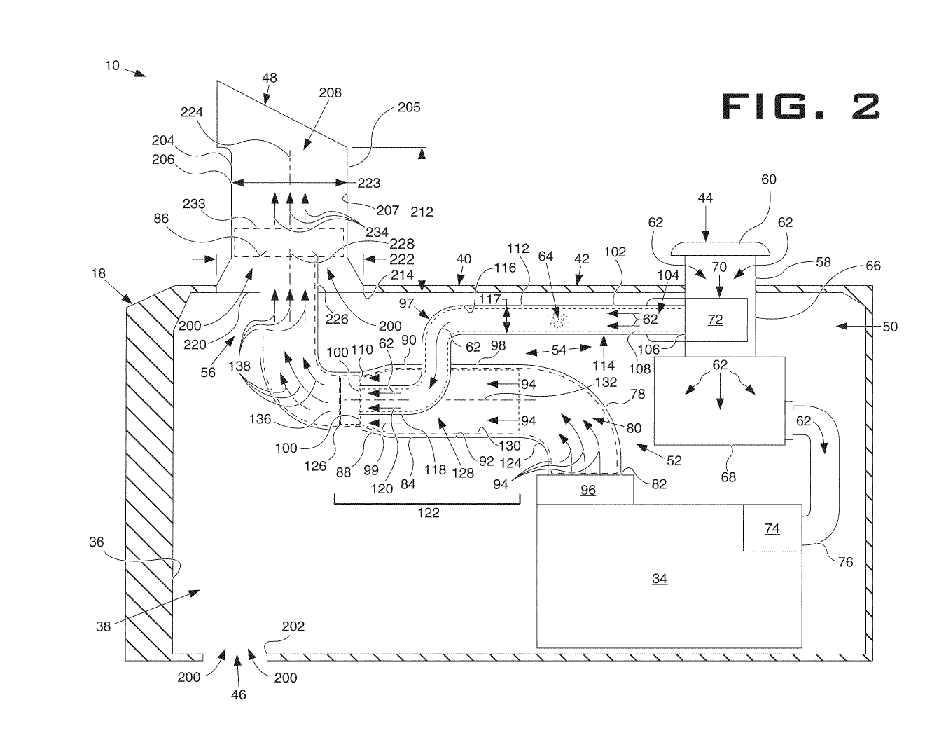

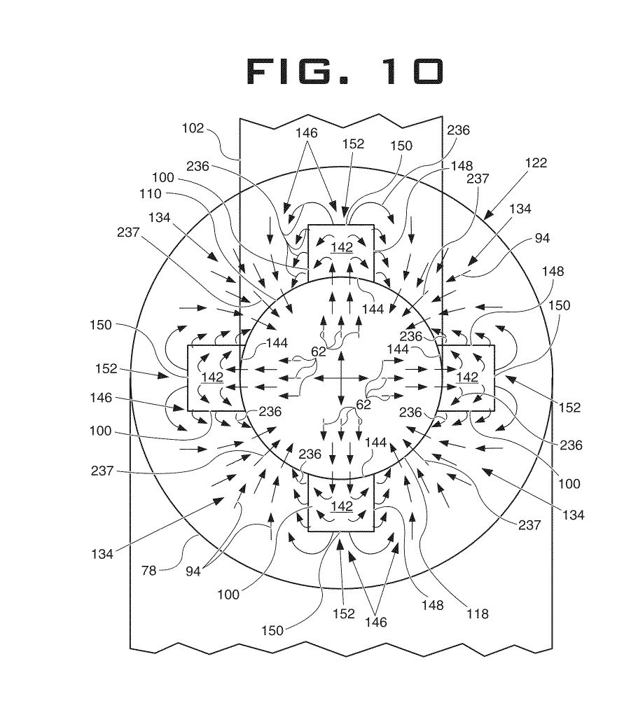

The present disclosure is directed to a gas flow system 10 for a machine 12. In particular, the presently disclosed gas flow system 10, as well as any one or more of the systems, features, components, and functionalities thereof according to any one or more of the embodiments as disclosed herein can be implemented and utilized with any of a variety of machines. For the purposes of providing one example of an operational application and implementation of the present disclosure, FIG. 1 shows a machine 12 within the context of a mobile machine 14, and in particular a wheel loader 16 which can incorporate and utilize a gas flow system 10 consistent with any one or more of the embodiments as disclosed herein and illustrated in more detail in the exemplary embodiments shown in FIGS. 2-17. However, without departing from the spirit and scope of the present disclosure, the machine 12 can be any mobile machine 14 which may perform one or more of types of operation associated with one or more industries including but not limited to mining, construction, farming, transportation, etc. and operates between or within work environments (e.g. construction site, mine site, power plants, on-highway applications, marine applications, etc.), including but not limited to automobiles, heavy trucks, busses, and other heavy highway vehicles, railway locomotives, construction, forestry, mining, agricultural, and industrial machines including but not limited to heavy off-highway construction trucks, mining trucks, articulated trucks, dozers, compactors, drag lines, excavators, tractors, loaders, scrapers, graders, cranes, backhoes, material handling equipment, dredgers, farming equipment and the like. In other embodiments, machine 12 may include a stationary machine, such as an electric power generator or a pumping station (not shown).

As shown in the exemplary embodiment illustrated in FIG. 1, the machine 12 can include a body 18. The body 18 of the machine 12 can include a frame as well as various additional structural members, coverings, housings, compartments, and the like which can form the structure of the machine 12 and support and/or house the various systems and components thereof, as further discussed herein. The machine 12 can also include a set of ground engaging propulsion devices 20, depicted as wheels, attached to and supporting the body 18. The machine 12 can also include systems that facilitate the operation of the machine 12. In the illustrated embodiment, these systems include a work implement system 22, a drive system 24, and a power system 26 that can provide power to the work implement system 22 and the drive system 24. The drive system can be operable to propel the machine 12 via the ground engaging propulsion devices 20 (depicted as wheels) to move the machine 12 from one location to another. In the context of the exemplary illustrated embodiment wherein the machine 12 is embodied as a wheel loader 16, the work implement system 22 can include at least one work implement 28 (depicted as a bucket) and actuators 30 (depicted as a hydraulic cylinder assemblies) to move the work implement 28, such as, for example, to do work at a worksite 32.

The power system of the machine 12 includes an engine 34. The engine 34 can include an internal combustion engine such as a diesel engine, a gasoline engine, a natural gas engine or any other engine which can produce a flow of gas, such as exhaust, as a by-product or incident to the operation thereof, such as, in one example, from the combustion of a combustible medium. The body 18 of the machine 12 can form a substantially enclosed, hollow compartment 36 defined therein, wherein the engine 34 can be housed or disposed, at least in part, within a hollow interior 38 of the compartment 36. In particular, and in one embodiment, the body 18 of the machine 12 can include a housing assembly 40, such as, for example, a hood and/or one or more body panels which not only can form and/or be exposed to the outer surface 42 of the machine 12 but also can form, surround and/or enclose the compartment 36, and the interior 38 thereof, in whole or in part, which can house the engine 34 therein. The body 18 of the machine 12 and/or the housing assembly 40 thereof and the compartment 36 disposed therein can additionally house, form, and/or support all or some of the gas flow system 10 and all, some, or a portion of the systems, features, elements, and components thereof as further shown in FIGS. 2-17 and discussed herein.

Specifically, and as illustrated in FIG. 1 and further shown in FIGS. 2-17, the gas flow system 10 can be defined as including, in part, a first gas inlet 44, a second gas inlet 46, and a gas outlet 48. The gas flow system 10 can additionally include an air filtration system 50, an exhaust system 52, a debris removal system 54, and a compartment cooling system 56, one or more of which may fluidly interact with one or more of the compartment 36, the first gas inlet 44, second gas inlet 46, and gas outlet 48 as provided herein. The first gas inlet 44, and in one embodiment, the air filtration system 50, can be formed, at least in part, by an inlet conduit 58 which can include an upper end extending from the outer surface 42 of the machine 12 having a rain cap 60 attached thereto, which may include a protective mesh or screen and can be configured to shield, filter or otherwise prevent larger pieces of dirt, dust, rock, mud, seeds, chaff, ash, and/or other larger foreign particles or substances from being fluidly communicated into the first gas inlet 44. The inlet conduit 58 can extend through the housing assembly 40 and into the compartment 36 to fluidly communicate a flow of first gas from the outer surface 42 of the machine 12 to the air filtration system 50 which can be housed within the interior 38 of the compartment 36. For the purposes of the present disclosure, by way of example and not by way of limitation, the flow of first gas, as well as the general direction and flow path thereof, is illustrated and depicted in the FIGS. 1-5 and 9-10 as the directional arrows labeled 62 and hereinafter referred to as “first gas flow 62.” Additionally, and for the purposes of providing an exemplary illustration of the present gas flow system 10, by way of example and not by way of limitation, the air filtration system 50, as well as the pre-cleaner 66, air filter 68, debris chamber 70, and debris collection area 72 thereof, discussed below, are shown as being substantially enclosed within the interior 38 of the compartment 36. However, the scope of the present disclosure is not limited to the foregoing exemplary illustrations, as in other embodiments, any one or more of the pre-cleaner 66, air filter 68, debris chamber 70, and debris collection area 72 of the air filtration system 50 can be fluidly connected and configured as disclosed herein but can be only partially enclosed within the compartment 36 or alternatively can be located outside of the compartment 36.

The first gas flow 62 may include air from outside the compartment 36, and in the embodiment illustrated in FIG. 1, air from the worksite 32 surrounding the outer surface 42 of machine 12. As such, the first gas flow 62 may include debris in the form of pieces of dirt, dust, rock, mud, seeds, chaff, ash, and/or other foreign particles or substances (hereinafter referred to as “debris 64”) as well as particles of dirt, dust, and/or other smaller foreign or particulate matter, which may become airborne and entrained in the first gas flow 62 entering the compartment 36. The air filtration system 50 can be connected in fluid communication to the first gas flow 62 between the first gas inlet 44 and the engine 34 and can be configured to entrap, contain, or otherwise filter the debris 64 as well as smaller particles of dirt, dust, and/or other smaller foreign or particulate matter entrained in the first gas flow 62 fluidly communicated from the outer surface 42 of the machine 12 via the first gas inlet 44 to the engine 34. In one embodiment, the air filtration system 50 can be configured to progressively filter the first gas flow 62 from the outer surface 42 of the machine 12 to first remove the debris 64 and subsequently remove the particles of dirt, dust, and/or other smaller foreign or particulate matter. In particular, and as shown in FIGS. 2 & 3, the air filtration system 50 can include a pre-cleaner 66 and an air filter 68. The pre-cleaner 66 can be positioned within the interior 38 of the compartment 36 and connected in fluid communication with the first gas flow 62 between the first gas inlet 44 and the air filter 68, and can be configured to entrap, contain, collect or otherwise filter and/or the debris 64 from the first gas flow 62 fluidly directed therethrough. The pre-cleaner 66 can include a debris chamber 70 which can include any substantially enclosed space or cavity within which the filtered debris 64 may collect or be contained, which, in the illustrated embodiment, is in the form of a debris collection area 72 which is contained in, and is an element of, the pre-cleaner.

With this configuration, the debris 64 in the first gas flow 62 flowing through the air filtration system 50 can be trapped in the debris collection area 72 of the pre-cleaner 66, wherein the first gas flow 62, which may be devoid of the trapped debris 64, can then be fluidly communicated to and directed through the air filter 68. A non-limiting example of an embodiment of air filtration system 50 includes the Donaldson STB Strata™ Air Cleaner including the Donaspin™ Pre-Cleaner. Although shown as an element of the air filtration system 50, the debris chamber 70 may include embodiments where additional filtering elements are not necessary, or embodiments in which the debris chamber 70 is not a component of the air filtration system 50.

The air filter 68 can be positioned within the interior 38 of the compartment 36 and connected in fluid communication with the first gas flow 62 between the pre-cleaner 66 and the engine 34, and in one example, an engine air intake manifold 74 which can fluidly connect the engine 34 to the outside of the compartment 36 and outer surface 42 of the machine 12 as well as the first gas flow 62 therefrom through the air filtration system 50. In particular, in one embodiment, the air filter 68 can be fluidly positioned downstream of the pre-cleaner 66 and upstream of the air intake manifold 74 of the engine 34. The air filter 68 can be configured to remove smaller particles of dirt, dust, and/or other foreign or particulate matter remaining in a portion of the first gas flow 62 which may be fluidly communicated to and directed through the air filter 68 from the pre-cleaner 66 and subsequently direct the portion of the first gas flow 62 to the air intake manifold 74 of the engine 34, which can be via engine inlet conduit 76.

The gas flow system 10 can also include an exhaust system 52 which can include, in part, an exhaust conduit 78. The exhaust conduit 78 can be defined as a substantially hollow channel, tube or pipe which can surround and substantially enclose a hollow interior 80 extending from a first or upstream end 82 which can be defined a gas flow inlet of an interior flow volume 84 of the exhaust conduit 78 to a second or downstream end 86 which can be defined a gas flow outlet of the interior flow volume 84 of the exhaust conduit 78. In particular, in one embodiment, the exhaust conduit 78 can be formed, in part, by a tubular exhaust conduit wall 88 which can include an exterior surface 90 as well as an interior surface 92 which can surround and form the hollow interior 80 in addition to the interior flow volume 84 which can extend along and throughout the length of the exhaust conduit 78 from the upstream end 82 to the downstream end 86 thereof. The exhaust conduit 78 can additionally be connected in fluid communication to receive and direct a flow of gas therethrough, which, in one embodiment, can include a flow of heated gas, for example, a flow of heated exhaust gas from the engine 34 or any other active or primary flow of gas that may be utilized, employed and/or otherwise directed to fluidly engage, influence, and/or interact with the various disclosed elements and gas flows of the presently disclosed exhaust and flow system 10 according to any one or more of the embodiments as provided herein. As a result, and for the purposes of the present disclosure, by way of example and not by way of limitation, the active or primary flow of gas, as well as the general direction and flow path thereof, is illustrated and depicted in the FIGS. 2-5 and 9-10 as the directional arrows labeled 94 and is illustratively referred to and designated herein as “primary gas flow 94”.

In particular, in one embodiment, the primary gas flow 94 can include a flow of heated gas, for example, a flow of heated exhaust gas from the engine 34. As such, and as shown in the illustrated embodiments, the upstream end 82 of the exhaust conduit 78 can be connected in fluid communication to the engine 34, and in one embodiment, can be connected in fluid communication to receive the primary gas flow 94 from the engine 34, which in one example can be via one or more aftertreatment devices 96. The primary gas flow 94 can thereafter be fluidly communicated along and throughout the interior flow volume 84 of the exhaust conduit 78 to the downstream end 86 thereof, which can be positioned to direct the primary gas flow 94 out of the compartment 36 via the gas outlet 48, as further discussed herein. In one embodiment, at least a portion of the exhaust conduit 78 can be positioned and substantially enclosed within the interior 38 of the compartment 36. In particular for the purposes of providing an exemplary illustration of the present gas flow system 10, by way of example and not by way of limitation, the air intake manifold 76, engine inlet conduit 76, exhaust conduit 78, the one or more aftertreatment devices 96 and the engine 34 are shown as being substantially enclosed within the interior 38 of the compartment 36. However, the scope of the present disclosure is not limited to the foregoing exemplary illustrations, as in other embodiments, any one or more of the air intake manifold 76, engine inlet conduit 76, exhaust conduit 78, the one or more aftertreatment devices 96 and the engine 34 can be fluidly connected and configured as disclosed herein but can be only partially enclosed within the compartment 36 or alternatively can be located outside of the compartment 36. Furthermore, although the engine 34 exhausts the primary gas flow 94 in the illustrated embodiment, in other embodiments the primary gas flow 94 may originate and be directed through the exhaust conduit 78 by other devices or processes known in the art. For example a manufacturing process may create heat and a series of fans, air conduits, and/or valves may direct the primary gas flow 94 through the exhaust conduit 78.

As illustrated by the exemplary embodiments shown in FIGS. 2-5, 9-11 & 17 the exhaust conduit 78, and the exhaust conduit wall 88 thereof, can be substantially cylindrical and can include a generally or substantially circular cross sectional profile extending along and throughout the length of the exhaust conduit 78 from the upstream end 82 to the downstream end 86 thereof. In alternative embodiments, the exhaust conduit 78 can be any substantially hollow, elongated tube or pipe having any shape or structure including but not limited to a tube like structure with cross sections in the shapes of ellipses or polygons such as octagons, rectangles, squares, and the like. Alternatively, or additionally, the exhaust conduit 78 can include cross sections which differ in shape and size at different points. In particular, and in some embodiments as further provided herein, the exhaust conduit 78 and exhaust conduit wall 88 thereof, can include, can be formed, and/or can be defined by a plurality of sections or segments which can have different shapes, sizes, dimensions, orientations, and/or features.

The gas flow system 10 can also include a debris removal system 54 which can include, in part, a first conduit 97, a second conduit 98 and at least one, or one or more tabs 100. The first conduit 97 can include a substantially hollow channel, tube or pipe which can be positioned or connected in fluid communication with the first gas flow 62 as well as the debris chamber 70. As such, in one embodiment, the first conduit 97 can be defined as, and/or can be defined as including a debris conduit 102 which can surround and substantially enclose a hollow interior 104 extending from a first or upstream end 106 which can be defined a gas flow inlet of an interior flow volume 108 of the debris conduit 102 to a second or downstream end 110 which can be defined a gas flow outlet of the interior flow volume 108 of the debris conduit 102. In particular, in one embodiment, the debris conduit 102 can be formed, in part, by a tubular debris conduit wall 112 which can include an exterior surface 114 as well as an interior surface 116 which can surround and form the hollow interior 104 in addition to the interior flow volume 108 which can extend along and throughout the length of the debris conduit 102 from the upstream end 106 to the downstream end 110 thereof. Furthermore, in one example, the debris conduit 102, as well as the debris conduit wall 112 thereof, can be substantially cylindrical and can include a substantially consistent diameter 117 and can extend along a substantially consistent circular cross sectional profile throughout the length of the debris conduit 102. In alternative embodiments, the debris conduit wall 112 can be any substantially hollow, elongated tube or pipe having any shape or structure including but not limited to a tube like structure with cross sections in the shapes of ellipses or polygons such as octagons, rectangles, squares, and the like. Alternatively, or additionally, the debris conduit wall 112 can include cross sections which differ in shape and size at different points.

The upstream end 106 of the debris conduit 102 can be attached, fluidly connected to, and/or connected in fluid communication with the debris chamber 70 and additionally can be positioned or connected in fluid communication to receive and direct a portion of the first gas flow 62, flowing through the first gas inlet 44 and into the debris collection area 72 of the debris chamber 70 of the pre-cleaner 66 (as well as any debris 64 therein), into the upstream end 106 and along and throughout the interior flow volume 108 of the debris conduit 102. The downstream end 110 of the debris conduit 102, and in one embodiment, a portion of the debris conduit 102 proximate to the downstream end 110 thereof, can be positioned in fluid communication with at least one of the hollow interior 80 of the second conduit 98 and the primary gas flow 94 fluidly communicated therethrough. In one embodiment, the debris conduit 102 can include a downstream end section 118 which can be defined as a fluidly integral, downstream-most section or segment of the debris conduit wall 112 which can be proximate to, and in one example, can be immediately adjacent to, can extend toward and can form and/or include the downstream end 110 of the debris conduit 102. In one embodiment, the downstream end section 118 of the debris conduit 102, and the debris conduit wall 112 thereof, can include a substantially consistent cross sectional profile and can extend substantially linearly and axially along and aligned with a central axis 120. In one example, the cross sectional profile of the downstream end section 118 of the debris conduit 102 and the debris conduit wall 112 thereof can additionally be substantially cylindrical with a substantially consistent circular cross sectional profile which can be substantially consistent with that of the debris conduit 102 as a whole. In alternative embodiments, the downstream end section 118 can include a different shape or structure, which can be any substantially hollow, elongated tube or pipe section having any shape or structure including but not limited to a tube like structure with cross sections in the shapes of ellipses or polygons such as octagons, rectangles, squares, and the like.

The second conduit 98 can include a hollow channel, tube or pipe which can be connected in fluid communication to direct the primary gas flow 94 therethrough, which in one example, and as provided above, can be a flow of heated exhaust gas from the engine 34. As such, the second conduit 98 can include the exhaust conduit 78, and in one embodiment, the exhaust conduit 78 can include a debris removal section 122 which can be formed by and/or can be defined as segment of the exhaust conduit 78. In particular, the debris removal section 122 of the exhaust conduit 78 can be defined as including and/or formed by a fluidly integral portion or section of the exhaust conduit 78 which can extend from a first or upstream end 124, which can be positioned at, proximate to, or downstream of and fluidly connected to receive the primary gas flow 94 from the first or upstream end 82 of the exhaust conduit 78, to a second or downstream end 126, which can be positioned upstream of the second or downstream end 86 of the exhaust conduit 78 and connected in fluid communication to direct the flow of gas, which can include the second flow of gas, out of the debris removal section 122 and into and through any remaining downstream portion of the exhaust conduit 78. Additionally, the debris removal section 122 of the exhaust conduit 78 can be defined as including and/or formed by a portion of the exhaust conduit wall 88, or one or more adjacently and fluidly attached and/or interconnected sections or segments of the exhaust conduit wall 88, which can define, surround and form the hollow interior 128 in addition to an interior flow volume 130 of the debris removal section 122 as a fluidly integral portion or segment of the hollow interior 80 and interior flow volume 84 of the exhaust conduit 78 extending along and throughout the length of the debris removal section 122 from the upstream end 124 to the downstream end 126 thereof. Furthermore, the debris removal section 122 of the exhaust conduit 78, and the interior flow volume 130 thereof, can extend substantially linearly from the upstream end 124 to the downstream end 126 thereof along and aligned with a central axis 132.

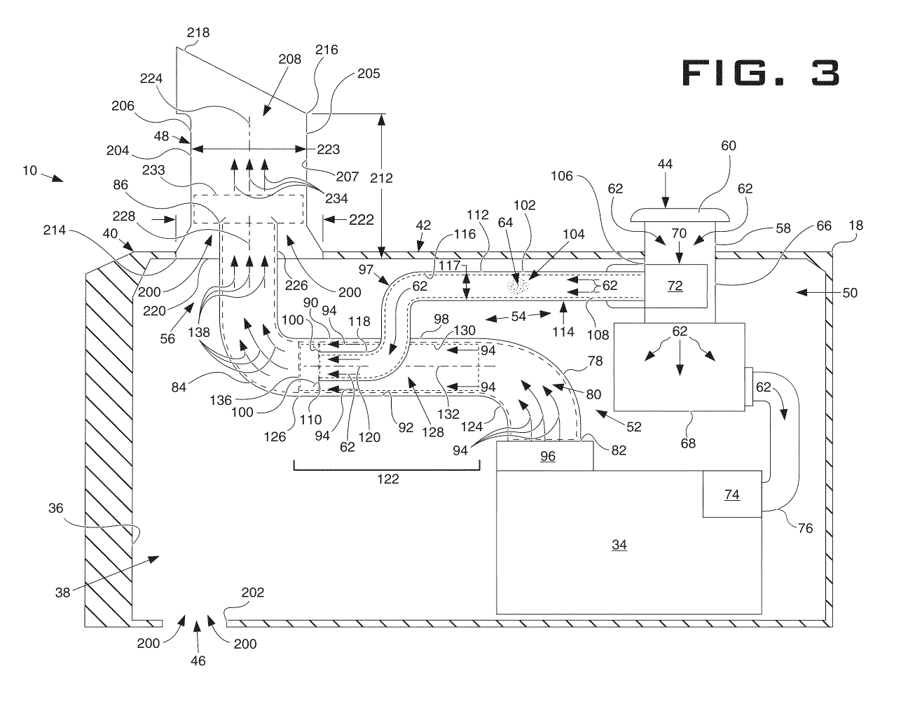

As shown by the exemplary embodiments illustrated in FIGS. 2-3 & 9-10, a portion of the debris conduit 102 including but not limited to the downstream end section 118 and the downstream end 110 can extend into and/or be positioned within the hollow interior 128 of the debris removal section 122 of the exhaust conduit 78, which can be via insertion through an aperture or opening in the exhaust conduit wall 88 of the debris removal section 122. Furthermore, the downstream end section 118 of the debris conduit 102 can extend into and/or be positioned within the hollow interior 128 of the debris removal section 122 with the downstream end 110 of the debris conduit 102 and the interior flow volume 108 thereof facing, adjacent, proximate, and/or otherwise oriented to open into the hollow interior 128 and interior flow volume 130 of the debris removal section 122 of the exhaust conduit 78 toward the downstream end 126 thereof. Additionally, in one embodiment, the downstream end section 118 can be positioned within the debris removal section 122 as provided above, wherein the central axis 120 of the downstream end section 118 of the debris conduit 102 can be substantially coaxially aligned with the central axis 132 of the debris removal section 122 of the exhaust conduit 78. Furthermore, the downstream end section 118 of the debris conduit 102 includes a diameter 133, which can be substantially consistent with that of the debris conduit 102 as a whole, wherein the diameter of the downstream end section 118 of the debris conduit 102 is smaller than the diameter or diameters of the exhaust conduit wall 88, or one or more sections or segments thereof, surrounding the downstream end section 118 of the debris conduit 102 to define a radial gap 134 within the interior flow volume 130 of the debris removal section 122 between the exterior surface 114 of the debris conduit wall 112 surrounding the downstream end 110 of the debris conduit 102 and the interior surface 92 or surfaces of the exhaust conduit wall 88, or segments thereof, of the debris removal section 122. For the purposes of providing an exemplary illustration of the debris removal system 54, by way of example and not by way of limitation, as provided above, the exhaust conduit 78 is shown as being at least partially enclosed within the interior 38 of the compartment 36 and similarly the debris conduit 102 is shown as being at least partially enclosed within the interior 38 of the compartment 36. However, the scope of the present disclosure is not limited to the foregoing exemplary illustrations, as in other embodiments, the debris conduit 102 and the exhaust conduit 78 as well as the additional elements of the debris removal system 54 can be included, connected, and arranged in a manner substantially consistent with any one or more of the embodiments as provided herein but can be only partially enclosed within the compartment 36 or alternatively can be located outside of the compartment 36. In particular, in some embodiments, such any one or more of the foregoing components of the debris removal system 54, including but not limited to the debris conduit 102 and the exhaust conduit 78 may be external components and may be connected as provided herein and may be at least partially exposed to the outer surface 42 of the machine 12 such as in embodiments wherein an internal compartment such as compartment 36 may be eliminated.

As provided above, the debris removal system 54 can also include one or more tabs 100. The tabs 100 can be configured to fluidly interact with, engage, and/or influence the interior flow volumes 130, 108, of the debris removal section 122 of the exhaust conduit 78 and the debris conduit 102, as well as the first gas flow 62 and the primary gas flow 94 respectively, fluidly communicated therethrough. In particular, the one or more tabs 100 can be positioned within the interior flow volume 130 of the hollow interior 128 of the debris removal section 122 of the exhaust conduit 78 proximate and/or adjacent to the downstream end 110 of the debris conduit 102 disposed therein. In addition, the one or more tabs 100 may be configured, in part, to fluidly interact in concert with the interior and exterior surfaces as well as the interior flow volumes within the debris removal section 122 of the exhaust conduit 78 as provided herein to facilitate, induce, generate, and/or otherwise create and maintain a scavenging or secondary flow of a portion of the first gas flow 62 through the interior flow volume 108 of the debris conduit 102 for debris 64 removal as well as a plurality of streamwise, stable, mixing vortex flows between the first gas flow 62 and the primary gas flow 94 within a mixing and vortex generation zone 136 which may occupy the internal space or volume within the debris removal section 122 of the exhaust conduit 78 extending substantially from the downstream end 110 of the debris conduit 102, to, proximate to, or downstream of the second or downstream end 110 of the debris removal section 122 of the exhaust conduit 78. As such, and as further provided herein, by virtue and/or operation of the one or more tabs 100 as well as the configurations of the presently disclosed embodiments of the debris removal system 54 and the exhaust system 52, a third gas flow which may be a combination, and in one example, a substantially even mixture of the primary gas flow 94 and the portion of the first gas flow 62 may be fluidly communicated from the mixing and vortex generation zone 136, to the downstream end 86 of the exhaust conduit 78. For the purposes of the present disclosure, by way of example and not by way of limitation, the third gas flow, as well as the general direction and flow path thereof, is illustrated and depicted in the FIGS. 2-3, 11 & 17 as the directional arrows labeled 138 and hereinafter referred to as “third gas flow 138”.

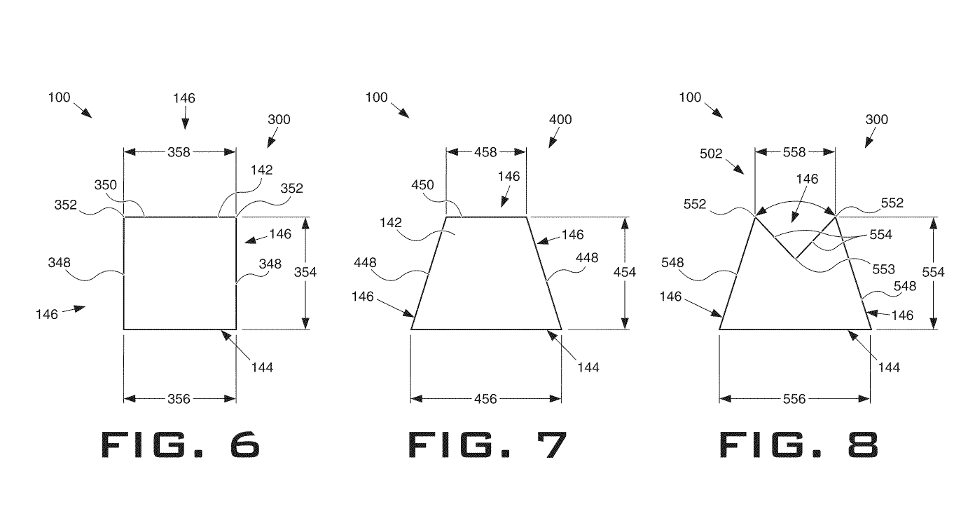

In particular, each of the one or more tabs 100 can include at least one upstream-facing surface 140, at least one downstream-facing surface 142, at least one base surface 144 and one or more or a plurality of boundary surfaces 146, as shown in the exemplary embodiments illustrated in FIGS. 2-5, 9 & 10 and further shown in FIGS. 6-8. Each upstream-facing surface 140 and downstream-facing surface 142 can be defined as and/or positioned on opposing substantially planar sides of one of the one or more tabs 100. In particular, in one embodiment, the upstream-facing surfaces 140 and downstream-facing surfaces 142 can be substantially flat, planar surfaces of the one or more tabs 100. In other embodiments, all or a portion of the upstream-facing surfaces 140 and downstream-facing surfaces 142 of the one or more tabs 100 can include contoured, arcuate and/or angled planar surfaces.

Each upstream-facing surface 140 can be positioned, oriented, or otherwise disposed within the interior flow volume 130 of the debris removal section 122 of the exhaust conduit 78 proximate to the downstream end 110 of the debris conduit 102 and generally facing the upstream end 124 of the debris removal section 122 to engage the primary gas flow 94 fluidly directed through the interior flow volume 130 of the debris removal section 122 of the exhaust conduit 78 and direct the primary gas flow 94 over and/or in fluid contact with one or more, or a plurality of boundary surfaces 146. Each downstream-facing surface 142 can be positioned, oriented, or otherwise disposed within the interior flow volume 130 of the debris removal section 122 proximate to the downstream end 110 of the debris conduit 102 and generally facing the downstream end 126 of the debris removal section 122 of the exhaust conduit 78 to engage and/or fluidly direct the portion of the first gas flow 62 fluidly directed out of the interior flow volume 108 via the downstream end 110 of the debris conduit 102 over and/or in fluid contact with one or more, or a plurality of boundary surfaces 146. The boundary surfaces 146 can include free, or un-attached outer or peripheral surfaces of and/or between the opposing upstream-facing surface 140 and downstream-facing surface 142, and in one embodiment, can define at least a portion of the outer profile or shape of each tab 100 as well as the upstream-facing surfaces 140 and downstream-facing surfaces 142 thereof, and can include a pair of lateral edges 148, at least one outer edge 150, and any one or more or a combination of corners, tips, and/or projections, as further provided herein. The base surface 144 of each tab 100 can be an interior, adjacent, and/or attached surface from which the upstream-facing surfaces 140, downstream-facing surfaces 142, and boundary surfaces 146 can extend, as further provided herein.

In one embodiment, one or more tabs 100, and the upstream-facing surfaces 140 and downstream-facing surfaces 142 thereof can be connected or otherwise positioned to extend radially outwardly from the downstream end 110 and the radial periphery of the exterior surface 114 of the debris conduit 102 into the hollow interior 128 of the debris removal section 122 toward the interior surface 92 of the exhaust conduit wall 88. In particular, the lateral edges 148 and the upstream facing surfaces 140 and downstream facing surfaces 142 of each tab 100 can extend radially outward from the base surface 144 which can be attached to, formed from, or otherwise positioned adjacent to the downstream end 110 of the debris conduit 102, into the hollow interior 128 of the debris removal section 122 to connect with one or more outer edges 150 extending therebetween. The one or more outer edges 150 of each tab 100 can be positioned adjacent and/or proximate to the interior surface 92 of the exhaust conduit wall 88 to form an outer radial gap 152 within the interior flow volume 130 of the debris removal section 122 between the one or more outer edges 150 of each tab 100 and the interior surface 92 of the exhaust conduit wall 88 of the debris removal section 122. Additionally, each tab 100, and the upstream-facing surface 140 and downstream-facing surface 142 thereof can extend radially outwardly from the second or downstream end 110 of the debris conduit 102 and angled toward the second or downstream end 110 of the debris removal section 122 of the exhaust conduit 78 at an angle 154 with respect to the central axis 120 of the downstream end section 118 of the debris conduit 102 and/or the center axis 132 of the debris removal section 122 of the exhaust conduit 78. In one example, each tab 100 can extend radially outwardly from the second or downstream end 110 of the debris conduit 102 and angled toward the second or downstream end 110 of the debris removal section 122 of the exhaust conduit 78 at an angle 154 of between twenty and eighty degrees (20°-80°). In another example, each tab 100 can extend radially outwardly from the second or downstream end 110 of the debris conduit 102 consistent with the foregoing at an angle 154 of between twenty and eighty degrees (30°-60°). Additionally, in one example, between one and sixteen tabs 100 can be evenly or unevenly spaced around and extending from the outer circumference of the downstream end 110 of the debris conduit 102. In another example, between three and six tabs 100 can be evenly or unevenly spaced around and extending from the outer circumference of the downstream end 110 of the debris conduit 102.

The one or more tabs 100 can also include a plurality of different shapes, profiles, and/or features. In particular, in the exemplary embodiment shown in FIG. 6, the tab 100 can be embodied as a substantially square or rectangular tab 300 and can include a pair of lateral edges 348 which extend outward from the base surface 144 to connect with an outer edge 350 to form a pair of corners 352 and define the length 354 of the upstream facing surface 140 and downstream facing surface 142 as well as that of the tab 300, wherein the base width 356 and outer width 358 of the corresponding surfaces and the tab 300 can be substantially equivalent to define the upstream facing surface 140 and the downstream facing surface 142 and the tab 300 as substantially square or rectangular. In another example of an exemplary tab 100 as shown in FIG. 7, a trapezoidal tab 400, and the upstream facing surface 140 and downstream facing surface 142 thereof, can include an outer edge 450 having an outer width 458 which is shorter than a base width 456 of the base surface 144, and can include a pair of tapered lateral edges 448 which extend inwardly at substantially equivalent angles from the base surface 144 to connect with the outer edge 450 and form corners 452 therewith and define the length 454 of the trapezoidal tab 400. FIG. 8 illustrates another embodiment of an exemplary tab 100 embodied as a sawtooth tab 500 including a sawtooth edge profile 502. The sawtooth tab 500 can include lateral edges 548, which can be tapered inwardly at substantially equivalent angles, which can extend from the base surface 144 along the length 554 of the sawtooth tab 500 to connect with and form outer tips 552 of the sawtooth edge profile 502 of the upstream facing surface 140 and downstream facing surface 142, which can include a pair of angled outer edges 550 which can extend between the outer tips 552 to form an angled interior corner 553 therebetween. Although the sawtooth tab 500 and sawtooth edge profile 502 thereof illustrated in FIG. 8 can include an outer width 558 which is shorter than a base width 556 of the base surface 144 to define a substantially trapezoidal shape such as that shown in FIG. 7, the sawtooth edge profile 502 can also be included to define the outer width and profile and/or can be included as forming one or more lateral edges 148 (such as 348) of a substantially square or rectangular tab 300 such as that shown in FIG. 6. Additionally, or alternatively, the sawtooth outer edge profile can also be incorporated into one or more lateral edges 148 (such as 348, 448, 548), and/or can include one or more pairs of angled outer edges (such as 550) which can form one or more interior corners and outer tips (such as 553, 552, respectively).

The base surface 144 of each tab 100 can be positioned and/or attached by any suitable means adjacent to the downstream end 110 of the debris conduit 102. The tabs 100, and the base surfaces 144 thereof, may each individually or together as a combined unit be fixedly attached to the debris conduit 102 through welding, adhesive, clamps, snap rings, bolts, or any other suitable means. Alternatively, the base surfaces 144 of the tabs 100 may be formed integral to the debris conduit 102. It is also contemplated that in some embodiments, the tabs 100 may be fixedly attached to another component(s) different than the debris conduit 102, and held stationary against the debris conduit 102, such that the base surfaces 144 are adjacent the downstream end 110 of the debris conduit 102. In still other embodiments, it is contemplated that the base surfaces 144 of the tabs 100 may be fixedly attached to another component(s) different than the debris conduit 102, but not adjacent the downstream end 110 of the debris conduit 102, such that the tabs 100, and the upstream-facing surfaces 140, downstream-facing surfaces 142, and boundary surfaces 146 thereof, fluidly interact with and/or engage the first gas flow 62 and the primary gas flow 94 and may form streamwise vortices and/or radial cross flows within and throughout the mixing and vortex generation zone 136 as provided further herein.

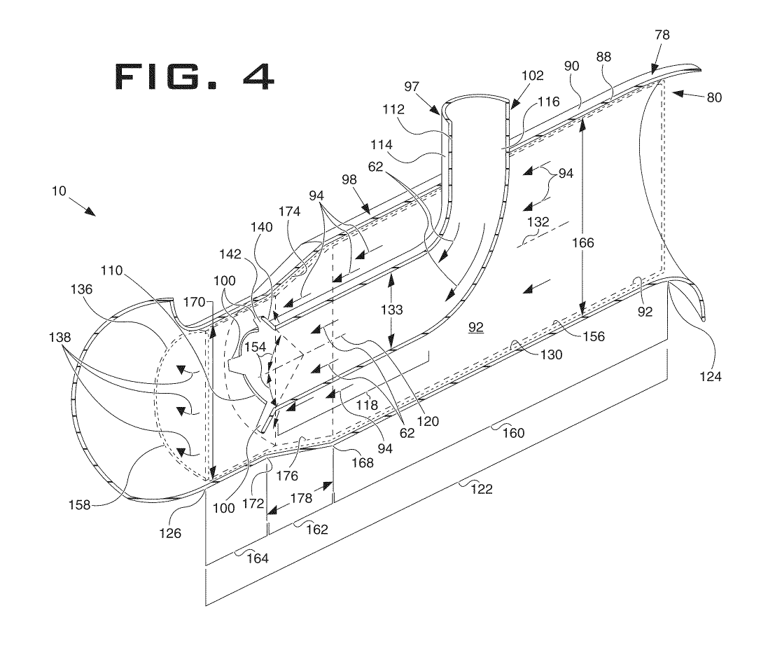

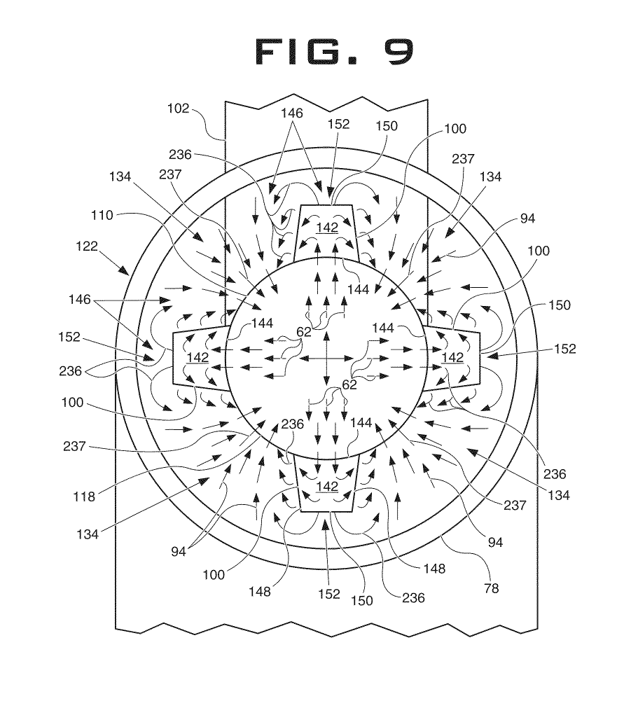

In the illustrated exemplary embodiments shown in FIGS. 9 & 10, four tabs 100 are circumferentially and substantially evenly spaced to extend outward radially outwardly from the downstream end 110 of the debris conduit 102 as provided above. However, without departing from the spirit and scope of the present disclosure, different numbers of tabs 100 may be evenly, or unevenly, spaced around and extending from the downstream end 110 of the debris conduit 102. In the exemplary embodiment illustrated in FIGS. 4-5 and 9-10 each tab 100 is generally the same size and shape, and is angled toward the second or downstream end 126 of the debris removal section 122 of the exhaust conduit 78 at substantially the same angle 154. In alternative embodiments, one or more, or each of the tabs 100 may be different shapes and sizes, and may extend from the downstream end 110 of the debris conduit 102 at different angles.

FIGS. 2, 4 and 9 illustrate one exemplary embodiment of the debris removal system 54 of the presently disclosed gas flow system 10. In the exemplary embodiment shown in FIGS. 2, 4 and 9, the debris removal section 122 of the exhaust conduit 78 can be configured to controllably and consistently reduce the interior flow volume 130 as well as the cross sectional flow area within the debris removal section 122 of the exhaust conduit 78 from an upstream first cross sectional flow area 156 to a decreased, second cross sectional flow area 158 which is smaller than the first cross sectional flow area 156, without providing a diffuser, an expanding internal flow volume, and/or a portion or section of the exhaust conduit wall 88 of the debris removal section 122 having a radially expanding diameter at and/or fluidly proximate to the downstream end 110 of the debris conduit 102 within the debris removal section 122. In the present exemplary embodiment, the first or upstream end 124 of the debris removal section 122 of the exhaust conduit 78 can include the first cross sectional flow area 156 as well as a first or upstream end diameter, such as first or upstream end diameter 166, as provided herein, and the second or downstream end 126 of the debris removal section 122 of the exhaust conduit 78 can include the decreased, second cross sectional flow area 158, as well as a decreased, second or downstream end diameter, such as decreased second or downstream end diameter 170 as provided herein, which is smaller and/or less than than the first or upstream end diameter 166 of the first cross sectional flow area 156. In particular, in one embodiment, the exhaust conduit wall 88 of the debris removal section 122 of the exhaust conduit 78 can include a first or upstream section 160, a second or downstream section 164, and a third or flow area reducing section 162. The first or upstream section 160 of the exhaust conduit wall 88 of the debris removal section 122 can include a substantially consistent first or upstream end diameter 166 which can surround and define the first cross sectional flow area 156 and can extend axially along and aligned with the central axis 132 from the upstream end 124 of the debris removal section 122 of the exhaust conduit 78 to a first or upstream end 168 of the flow area reducing section 162 of the exhaust conduit wall 88. The second or downstream section 164 can include a decreased, substantially consistent second or downstream end diameter 170 (wherein the downstream end diameter 170<the upstream end diameter 166) which can surround and define the decreased, second cross sectional flow area 158 and can extend axially along and aligned with the central axis 132 of the debris removal section 122 from a second or downstream end 172 of the flow area reducing section 162 of the exhaust conduit wall 88 to the second or downstream end 126 of the debris removal section 122 of the exhaust conduit 78. In one embodiment, the decreased second or downstream end diameter 170 can be maintained and can be substantially consistent to define the diameter of the portion of the exhaust conduit 78 and exhaust conduit wall 88 extending from the downstream end 126 of the debris removal section 122 to the downstream end 86 of the exhaust conduit 78 (including, in one example, the diameter 231 of the downstream end section 226 thereof, as discussed herein).

The third or flow area reducing section 162 of the exhaust conduit wall 88 can be tapered, angled, and/or otherwise configured, in part, to reduce the interior flow volume 130 and cross sectional flow area of the debris removal section 122 of the exhaust conduit 78 from the first cross sectional flow area 156 of the upstream section 160 to the decreased second cross sectional flow area 158 of downstream section 164 of the exhaust conduit wall 88. In particular, the flow area reducing section 162 of the exhaust conduit wall 88 can include an interior surface 174 as well as a decreasing cross sectional flow area 176, which can be sloped, angled and/or tapered radially inwardly toward the central axis 132 of the debris removal section 122 of the exhaust conduit 78 as the flow area reducing section 162 of the exhaust conduit wall 88 and the interior surface 174 thereof extends from its upstream end 168, which can include a diameter substantially equivalent to the upstream end diameter 166 of the upstream section 160, to its downstream end 172, which can include a diameter substantially equivalent to the decreased downstream end diameter 170 of the downstream section 164 of the exhaust conduit wall 88. In one embodiment, the upstream section 160 and the downstream section 164 of the exhaust conduit wall 88 of the debris removal section 122 can be substantially cylindrical, wherein the flow area reducing section 162 can be sloped, angled, and/or tapered therebetween as provided above to define the flow area reducing section 162 as including a substantially cylindrical, tapered or angled conical, or frusto-conical section and interior surface 174 of the exhaust conduit wall 88. Additionally, the sloped, angled and/or tapered flow area reducing section 162 of the exhaust conduit wall, and the interior surface 174 thereof can reduce the interior flow volume 130 and the diameter of the of the debris removal section 122 of the exhaust conduit 78 along an axial length 178 which can extend from the upstream end 168 to the second or downstream end 172 of the flow volume reducing section 162 of the exhaust conduit wall 88.

Consistent with the foregoing, the downstream end section 118 of the debris conduit 102 can be positioned within the interior 128 of the debris removal section 122 of the exhaust conduit 78 with its downstream end 110 facing, adjacent, proximate, and/or otherwise oriented toward the downstream end 126 of the debris removal section 122 and its central axis 120 substantially coaxially aligned with the central axis 132 of the debris removal section 122. Additionally, in the present embodiment, the downstream end 110 of the debris conduit 102 can be positioned within the interior 128 of the debris removal section 122 of the exhaust conduit 78 at one of a plurality of positions along the axial length 178 of the sloped, angled and/or tapered flow area reducing section 162 of the exhaust conduit wall 88 between the upstream end 168 and the second or downstream end 172 thereof. In one embodiment, the downstream end 110 of the debris conduit 102 can be positioned within the flow area reducing section 162 of the exhaust conduit wall 88, downstream of the upstream end 168 of the flow area reducing section 162. Additionally, in one example, the downstream end 110 of the debris conduit 102 can be positioned at and substantially aligned with or proximate to the downstream end 172 of the flow area reducing section 162 such that a portion of, or substantially all of the exhaust conduit wall 88 of the flow area reducing section 162, and the interior surface 174 thereof, can be sloped, angled and/or tapered toward the second or downstream end 110 of the debris conduit 102, as well as the one or more tabs 100, extending outward therefrom.

As provided herein, the debris removal section 122, the debris conduit 102, as well as the downstream end section 118 and one or more tabs 100 thereof, can be positioned, oriented, relatively sized and/or otherwise configured to form and maintain stable, sustained streamwise vortices 236 and radial cross flows 237, as discussed herein, within the mixing and vortex generation zone 136 and maintain a substantially consistent flow ratio between the first gas flow 62 fluidly directed through the debris conduit 102 and the primary gas flow 94 fluidly directed through the debris removal section 122 of the exhaust conduit 78 over a wide range of flow rates, including lower peak velocities of the primary gas flow 94 directed through the interior flow volume 130 of the debris removal section 122 such that flow separation, peak velocity, and flow resistance, as well as flow/fluid noise, may be reduced or substantially eliminated. In one example of the present embodiment, the flow area reducing section 162 can be configured to reduce the diameter, flow area, and interior flow volume 130 of the debris removal section 122 of the exhaust conduit 78, and in particular, can be configured to reduce the first cross sectional flow area 156 and the upstream end diameter 166 of the upstream section 164 by between 10% and 30%, and in one example, between 15% and 25%, as the flow area reducing section 162 extends axially from its upstream end 168 to its downstream end 172, which can include and define the (10%-30%, and in one example, a 15%-25% reduced) downstream end diameter 170 of the downstream section 164 of the exhaust conduit wall 88. Additionally, in one example, the flow area reducing section 162 can be configured to reduce the first cross sectional flow area 156 and the upstream end diameter 166 as provided by any one or more of the foregoing examples, along its axial length 178 which can be measured or defined as a ratio of between 20% and 50%, and in one example, between 30% and 40% of the upstream end diameter 166.

Furthermore, the upstream section 160 and the downstream section 164, and the first and second diameters 166, 170 thereof, respectively, can be positioned, oriented and/or relatively sized with respect to the diameter 117 of the debris conduit 102, and the diameter 133 of the downstream end section 118 thereof. In particular, in one embodiment, the relative size and/or proportion of the upstream end section 160 can be measured or defined with reference to the debris conduit 102, wherein the diameter 133 of the downstream end section 118, which can be substantially equivalent to the diameter 117 of the debris conduit 102 can be measured or defined as a ratio of between 25% and 55%, and in one example, between 35% and 45% of the upstream end diameter 166 of the upstream section 160. Additionally, the relative size of the downstream section 164 can be measured or defined with reference to the debris conduit 102, wherein the diameter 133 of the downstream end section 118, which can be substantially equivalent to the diameter 117 of the debris conduit 102 can be measured or defined as a ratio of between 35% and 65%, and in one example, between 45% and 55% of the downstream end diameter 170 of the downstream section 164. Furthermore, as provided above, in one example, the downstream end 110 of the debris conduit 102 can include between one and sixteen tabs 100 and in one example, between three and six tabs 100, and is shown as including four evenly spaced tabs 100. In one embodiment, the base width, which can include any one of base width 356, 456, 556, as well as the length, which can include any one of length 354, 454, 554, of each tab 100 can be measured or defined with reference to the debris conduit 102 and can be between 30% and 50%, and in one example, between 35%-45% of the diameter 133 of the downstream end section 118, which can be substantially equivalent to the diameter 117 of the debris conduit 102. Additionally, in an example wherein the downstream end 110 of the debris conduit 102 can include trapezoidal tabs 400 or alternatively can include sawtooth tabs 500, the outer width, which can include outer width 458 or outer width 558, respectively, measured or defined with reference to and can be between 45% and 65%, and in one example, between 50%-60% of the base width 456 or base width 556 of the respective tabs 400, 500.

FIGS. 3, 5 and 10 illustrate another exemplary embodiment of the debris removal system 54 of the presently disclosed gas flow system 10. In particular, in the present exemplary embodiment, the portion of the exhaust conduit wall 88 of the debris removal section 122 of the exhaust conduit 78 can include and can extend substantially linearly along a substantially smooth, constant cross sectional profile from its upstream end to its second or downstream end 126 without providing a diffuser, an expanding internal flow volume, and/or a portion or section of the exhaust conduit wall 88 of the debris removal section 122 having a radially expanding diameter at and/or fluidly proximate to the downstream end 110 of the debris conduit 102 within the debris removal section 122. Although a variety of tube-type cross sectional shapes are contemplated as falling within the scope of the present disclosure as provided above, in one example, the cross sectional flow area 182, as well as the portion of the exhaust conduit wall 88 and interior surface 184 thereof which can define the debris removal section 122 of the exhaust conduit 78 can extend substantially linearly and axially along and can include a substantially circular, constant diameter 186 cross sectional profile which can be aligned with its central axis which can extend from its upstream end 124 to its second or downstream end 126.

Additionally, the second or downstream end section 118 of the debris conduit 102 can be positioned within the substantially consistent, linear cross sectional flow area 182 of the debris removal section 122 of the exhaust conduit 78 such that the downstream end 110 of the debris conduit 102 is facing, adjacent, proximate, and/or otherwise oriented to open into the hollow interior 128 and cross sectional flow area 182 of the debris removal section 122 of the exhaust conduit 78 toward the second or downstream end 126 thereof. In the present embodiment, the second or downstream end section 118 of the debris conduit 102, and the central axis 120 thereof, can be positioned within the interior 128 of the debris removal section 122 of the exhaust conduit 78 substantially coaxially aligned with the central axis 132 of the debris removal section 122 of the exhaust conduit 78. Additionally, the second or downstream end section 118 of the debris conduit 102 can be positioned within the debris removal section 122 of the exhaust conduit 78 such that the downstream end 110 of the debris conduit 102 is positioned within the substantially consistent, linear cross sectional flow area 182 between the upstream end 124 and the second or downstream end 126 of the debris removal section 122 of the exhaust conduit 78. Furthermore, the second or downstream end 110 of the debris conduit 102 can include one or more tabs 100 which can extend radially outward into the interior flow volume 182 of the debris removal section 122 of the exhaust conduit 78 toward the substantially straight, linear interior surface 184 portion of the exhaust conduit wall 88 of the debris removal section 122 of the exhaust conduit 78.

Consistent with the foregoing and as provided herein, in the presently discussed embodiment, the debris removal section 122, the debris conduit 102, as well as the downstream end section 118 and one or more tabs 100 thereof, can be positioned, oriented, relatively sized and/or otherwise configured to form and maintain stable, sustained streamwise vortices 236 and radial cross flows 237, as discussed herein, within the mixing and vortex generation zone 136 and maintain a substantially consistent flow ratio between the first gas flow 62 fluidly directed through the debris conduit 102 and the primary gas flow 94 fluidly directed through the debris removal section 122 of the exhaust conduit 78 over a wide range of flow rates, including lower peak velocities of the primary gas flow 94 directed through the interior flow volume 130 of the debris removal section 122 such that flow separation, peak velocity, and flow resistance, as well as flow/fluid noise, may be reduced substantially. In the presently discussed embodiment, the debris removal section 122 can be configured to maintain a consistent cross sectional flow area 182 and diameter 186 and can be positioned, oriented and/or relatively sized with respect to the diameter 117 of the debris conduit 102, and the diameter 133 of the downstream end section 118 thereof. In particular, in one embodiment, the relative size and/or proportion of the debris removal section 122 including the cross sectional flow area 182 and diameter 186 of the present embodiment can be measured or defined with reference to the debris conduit 102, wherein the diameter 133 of the downstream end section 118, which can be substantially equivalent to the diameter 117 of the debris conduit 102 can be measured or defined as a ratio of between 30% and 60%, and in one example, between 40% and 50% of the debris removal section 122 diameter 186 of the instant embodiment.

Furthermore, as provided above, in one example, the downstream end 110 of the debris conduit 102 can include between one and sixteen tabs 100 and in one example, between three and six tabs 100, and is shown as including four evenly spaced tabs 100. In one embodiment, the base width, which can include any one of base width 356, 456, 556, as well as the length, which can include any one of length 354, 454, 554, of each tab 100 can be measured or defined with reference to the debris conduit 102 and can be between 30% and 50%, and in one example, between 35%-45% of the diameter 133 of the downstream end section 118, which can be substantially equivalent to the diameter 117 of the debris conduit 102. Additionally, in an example wherein the downstream end 110 of the debris conduit 102 can include trapezoidal tabs 400 or alternatively can include sawtooth tabs 500, the outer width, which can include outer width 458 or outer width 558, respectively, measured or defined with reference to and can be between 45% and 65%, and in one example, between 50%-60% of the base width 456 or base width 556 of the respective tabs 400, 500.

The gas flow system 10 can also include a compartment cooling system 56 which can include, in part, the compartment 36, the second gas inlet 46, the gas outlet 48, the second conduit 98 and at least one, or one or more tabs 600. As provided above, the compartment 36 can be substantially hollow and additionally can be formed, substantially surrounded and/or substantially enclosed by the body 18 of the machine 12, and in one embodiment, the housing assembly 40 thereof. In addition, the compartment 36 can include a plurality of components substantially, or alternatively, partially, disposed and housed within the interior 38 thereof, including but not limited to the engine 34, the aftertreatment devices 96, the exhaust system 52, the air filtration system 50, and the debris removal system 54. Any one or more of the foregoing components, including but not limited to the engine 34 and the aftertreatment devices 96, may transfer heat into the compartment 36, such as through convection, radiation and/or otherwise, as shown by the arrows marked “H”. In other embodiments, the compartment 36 may enclose other components. Exemplary non-limiting components include mufflers, hydraulic pumps, transmissions, gear boxes, and hydraulic valves. Some, none, or all, of these other components may also transfer heat into the compartment 36 such as through convection radiation and/or otherwise. As such, and as provided herein, the compartment cooling system 56 can be configured to draw and circulate gas and/or configured to assist in drawing and circulating gas into and through the compartment 36 to cool the components within the compartment 36 and dissipate the heat transferred therefrom.

The compartment cooling system 56 can additionally include the second gas inlet 46. The second gas inlet 46 can be connected and/or positioned in fluid communication with the interior 38 of the compartment 36 and can be configured to provide one or more flow paths through which a second gas flow can be fluidly communicated into the interior 38 of the compartment 36, which can be via the second gas inlet 46 in conjunction with the compartment cooling system 56, as provided herein. For the purposes of the present disclosure, by way of example and not by way of limitation, the second gas flow, as well as the general direction and flow path thereof, is illustrated and depicted in the FIGS. as the directional arrows labeled 200 and hereinafter referred to as “second gas flow 200”. The second gas flow 200 may include air, which may be ambient temperature air from outside the compartment 36 such as air from the worksite 32 surrounding the outer surface 42 of machine 12, and in the illustrated embodiment, the second gas inlet 46 can include at least one aperture 202 into and through which the second gas flow 200 can be fluidly communicated into the interior 38 of the compartment 36. To provide an exemplary illustration and description, by way of example and not by way of limitation, one aperture 202 is shown positioned at the bottom of the compartment 36 in the exemplary embodiments of FIGS. 1-3. However, the scope of the present disclosure is not limited to the foregoing exemplary embodiment, as the second gas inlet 46 of the compartment 36 can include one or more or a plurality of apertures, which may be disposed through the body 18 of the machine 12 and/or the housing assembly 40 thereof, and may include vents, cracks, or an open side of the compartment 36. Additionally, or alternatively, in some embodiments the second gas flow 200 may flow through a tube, or other ductwork, to the second gas inlet 46.

The gas outlet 48 can be connected and/or positioned in fluid communication with the interior 38 of the compartment 36 as well as the second conduit 98 and configured to fluidly direct the gases therein and/or fluidly communicated therethrough out of the compartment 36 to be disbursed to the air surrounding the outer surface 42 of the machine 12. In particular, and as shown in FIGS. 1-3, 11 & 17, the gas outlet 48 can include a gas outlet conduit 204. The gas outlet conduit 204 can be defined as a gas outlet stack or exhaust stack and can include one or more adjacently and fluidly attached and interconnected hollow channels, tubes or pipes. In particular, the gas outlet conduit 204 can be formed, in part, by a tubular gas outlet conduit wall 205 which can include an exterior surface 206 as well as an interior surface 207 which can surround and form a hollow interior 208 as well as an interior flow volume 210 extending substantially along the interior axial and/or longitudinal length 212 of the gas outlet 48 from a first or upstream end 214, which can be defined a gas flow inlet of the interior flow volume 210 of the gas outlet 48, to a second or downstream end 216 which can be defined a gas flow outlet of the interior flow volume 210 of the gas outlet 48. In one embodiment, the gas outlet conduit 204 may include an angled outlet duct 218 at or above its second or downstream end 216. In particular, in one embodiment, the debris conduit 102 can be formed, in part, by a tubular debris conduit wall 112 which can include an exterior surface 114 as well as an interior surface 116 which can surround and form the hollow interior 104 in addition to the interior flow volume 108 which can extend along and throughout the length of the debris conduit 102 from the upstream end 106 to the downstream end 110 thereof. As illustrated in the exemplary embodiments shown in FIGS. 2-3, 11 & 17, the upstream end 214 of the gas outlet 48 can include and/or be defined as an opening 220 within the hollow interior 38 of the compartment 36 which can extend through the body 18 and in one embodiment, the housing assembly 40 of the machine 12, and can fluidly connect the hollow interior 38 of the compartment 36 in fluid communication with the interior 208 and interior flow volume 210 of the gas outlet 48, and gas outlet conduit 204 thereof. In one embodiment, the opening 220 which can define and form the upstream end 214 of the gas outlet 48, and in one example, the gas outlet conduit 204 thereof, can include a substantially cylindrical cross section as well as a diameter 222 through and into which the gases within the compartment 36 the second conduit 98 may be fluidly communicated. Furthermore, in one example, the gas outlet conduit 204, as well as the gas outlet conduit wall 205 thereof, can be substantially cylindrical and can include a substantially and/or generally consistent diameter 223 and can extend along a substantially and/or generally consistent circular cross sectional profile throughout the length of the gas outlet conduit 204. Additionally, the gas outlet 48, as well as the opening 220 and gas outlet conduit 204 thereof, can be oriented to extend substantially linearly along a central axis 224 along and throughout the interior 208 and interior flow volume 210 from the upstream end 214 to the downstream end 216 of the gas outlet conduit 204, which may be positioned to extend outward from and above the outer surface 42 of the housing assembly 40.

In one embodiment, the gas outlet 48, in conjunction with the second gas inlet 46, the second conduit 98, the one or more tabs 600 and additional components of the compartment cooling system 56, can be configured to fluidly draw, induce, or otherwise fluidly communicate the second gas flow 200 through the interior 38 of the compartment 36 and fluidly direct the second gas flow 200 as well as the third gas flow 138 out of the compartment 36 and the second conduit 98, respectively, and into and through the interior flow volume 210 of the gas outlet conduit 204 and to the air surrounding the outer surface 42 of the machine 12. As provided above, the second conduit 98 can include the exhaust conduit 78, which can be connected in fluid communication to receive and direct a primary gas flow 94 therethrough, which can be a flow of heated exhaust gas from the engine 34, and additionally can be fluidly connected to the downstream end 110 of the debris conduit 102, and may receive and direct a combination and/or mixture of primary gas flow 94 and the portion of the first gas flow 62 as a third gas flow 138 to the downstream end 86 of the exhaust conduit 78. In one embodiment, the downstream end 86 of the exhaust conduit 78 can include a downstream end section 226 which can be defined as a fluidly integral, downstream-most section or segment of the exhaust conduit wall 88 which can be proximate to, and in one example, can be immediately adjacent to, can extend toward and can form the downstream end 86 of the exhaust conduit 78. The downstream end section 226 can also include an interior flow volume 227, which can be defined as a fluidly integral, downstream-most gas flow outlet portion of the interior flow volume 84 of the exhaust conduit 78.

Additionally, in one embodiment the downstream end section 226 of the exhaust conduit 78, and the exhaust conduit wall 88 thereof, can include a substantially consistent cross sectional profile and can extend substantially linearly and axially along and aligned with a central axis 228. In one example, the cross sectional profile of the downstream end section 226 of the exhaust conduit 78 and the exhaust conduit wall 88 thereof can additionally be substantially cylindrical with a substantially consistent circular cross sectional profile, which can be substantially consistent with the portion of the exhaust conduit 78 and exhaust conduit wall 88 extending from the downstream end 126 of the debris removal section 122 to the downstream end section 226 of the exhaust conduit 78. In alternative embodiments, the downstream end section 226 can include a different shape or structure, which can be any substantially hollow, elongated tube or pipe section having any shape or structure including but not limited to a tube like structure with cross sections in the shapes of ellipses or polygons such as octagons, rectangles, squares, and the like.

The downstream end section 226 of the exhaust conduit 78 can be positioned or otherwise oriented such that the downstream end 86 of the exhaust conduit 78, and the one or more tabs 600, as further provided herein, can be positioned to fluidly interact with, fluidly engage, and/or influence the interior 38 of the compartment 36 as well as the interior flow volume 210 of the gas outlet 48. As shown by the exemplary embodiments illustrated in FIGS. 2-3, 11 & 17, in addition to other portions as provided herein, at least a portion of the exhaust conduit 78 and exhaust conduit wall 88 extending from the downstream end 126 of the debris removal section 122 to the downstream end section 226 of the exhaust conduit 78 can be positioned within and can extend through the interior 38 of the compartment 36 toward the gas outlet 48 such that the downstream end 86 the exhaust conduit 78 can be positioned in fluid communication and proximity with the interior 208 and interior flow volume 210 of the gas outlet 48 as well as the interior 38 of the compartment 36. In particular, the downstream end 86 of the exhaust conduit 78 and the downstream end section 226 thereof, can be positioned at or substantially aligned with the opening 220, or alternatively, the downstream end 86 and at least a portion of the downstream end section 226 (and the interior flow volume 227 thereof) can extend into and through the opening 220 at the upstream end 214 of the gas outlet conduit 204 at any one of a plurality of positions along an axial length 230 which extends from the upstream end 214 of the gas outlet 48 into the interior flow volume 210 and hollow interior 208 of the gas outlet conduit 204 such that the downstream end 86 of the exhaust conduit 78, and the one or more tabs 600, as further provided herein, can be positioned in fluid communication to fluidly interact with, engage, and/or influence the interior 38 of the compartment 36 as well as the interior flow volume 210 of the gas outlet 48.

In addition, in one embodiment, and as illustrated in FIGS. 2-3, 11 & 17, the downstream end 86 of the exhaust conduit 78 can be positioned proximate to, substantially laterally aligned with, and/or can extend into and through the opening 220 such that the central axis 228 of the downstream end section 226 of the exhaust conduit 78 can be substantially coaxially aligned with the central axis 224 of the opening 220 and the gas outlet conduit 204. Additionally, and as further illustrated in FIGS. 2-3, 11 & 17, in one embodiment the downstream end section 226 of the exhaust conduit 78 can include a diameter 231, which can be smaller than the diameter 222 of opening 220 which can form the upstream end 214 of the gas outlet 48 to define a radial gap 232 between the exterior surface 90 of the exhaust conduit wall 88 of the downstream end section 226 of the exhaust conduit 78 and the interior surface 207 of the gas outlet conduit 204 and the opening 220 thereof. As such, the second gas flow 200 from the interior 38 of the compartment 36 may be fluidly drawn or otherwise communicated into and through the opening via the radial gap 232, and in some embodiments, between the exterior surface 90 of the exhaust conduit wall 88 of the downstream end section 226 of the exhaust conduit 78 and the interior surface 207 of the gas outlet conduit 204 and into the interior flow volume 210 of the gas outlet conduit 204 proximate to and in fluid communication with the downstream end 86 of the exhaust conduit 78.

As provided above, the compartment cooling system 56 can additionally include one or more tabs 600. In particular, the one or more tabs 600 can be positioned proximate and/or adjacent to the downstream end 86 of the exhaust conduit 78 in fluid communication with the interior flow volume 227 of the downstream end section 226 and additionally can be positioned to fluidly interact with, fluidly engage, and/or influence, and/or otherwise in fluid communication with the interior 38 of the compartment 36 as well as the interior 208 and the interior flow volume 210 of the gas outlet 48. In particular, the one or more tabs 600 may be configured, in part, and in concert with the downstream end 86 of the exhaust conduit 78 as well as the interior flow volume 227 of the downstream end section 226 and the interior flow volume 210 of the gas outlet conduit 204, to fluidly draw, induce, or otherwise fluidly communicate and maintain a second gas flow 200 through the interior 38 of the compartment 36 and into the gas outlet conduit 204 as well as a plurality of streamwise, stable, mixing vortex flows between the second gas flow 200 and the third gas flow 138 within a mixing and vortex generation zone 233 which may occupy an internal space or volume within the gas outlet conduit 204 downstream of the downstream end 86 of the exhaust conduit 78 and downstream end section 226 thereof. As such, and as further provided herein, by virtue and/or operation of the tabs 600 as well as the configurations of the presently disclosed embodiments of the compartment cooling system 56, a fourth gas flow, which may be a combination, and in one example, a substantially even mixture of the third gas flow 138 and the second gas flow 200, may be fluidly communicated from the mixing and vortex generation zone 233 and/or the downstream end 86 of the exhaust conduit 78 through the interior flow volume 210 of the gas outlet conduit 204 and to the air surrounding the outer surface 42 of the machine 12. For the purposes of the present disclosure, by way of example and not by way of limitation, the fourth gas flow, as well as the general direction and flow path thereof, is illustrated and depicted in the FIGS. 1-3 & 11 as the directional arrows labeled 234, and hereinafter referred to as “fourth gas flow 234”.

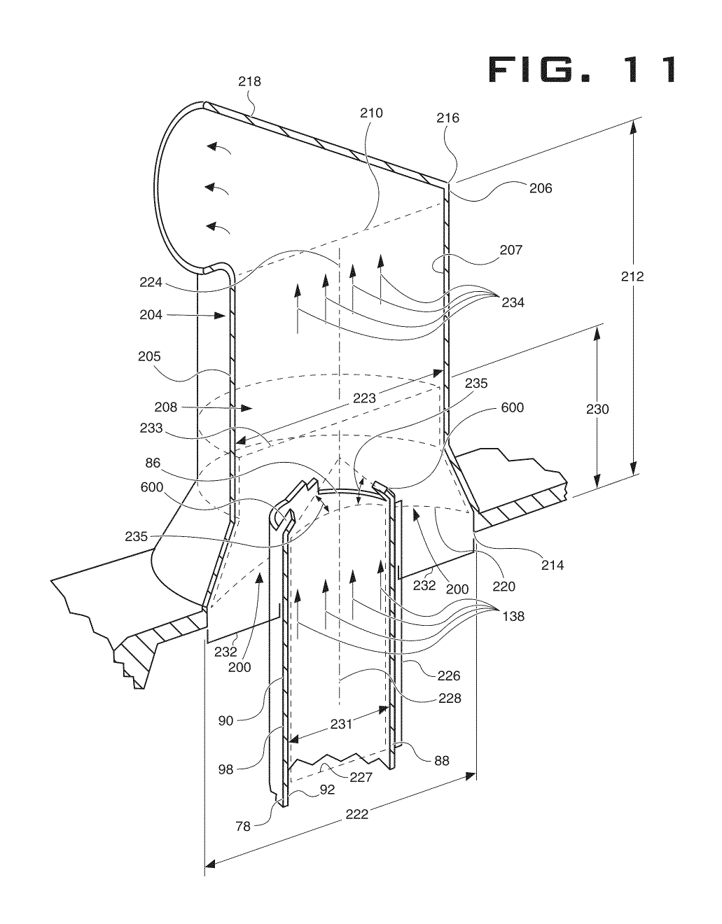

In a manner substantially consistent with any one or more of the foregoing embodiments directed to the one or more tabs of the debris removal system 54, each of the one or more tabs 600 of the compartment cooling system 56 can include at least one upstream-facing surface 640, at least one downstream-facing surface 642, at least one base surface 644 and one or more or a plurality of boundary surfaces 646, as shown in the exemplary embodiments illustrated in FIGS. 2-3, 11 & 17 and further shown in FIGS. 12-16. Similar to the foregoing embodiments, each upstream-facing surface 640 and downstream-facing surface 642 can be defined as and/or positioned on opposing substantially planar sides of one of the one or more tabs 600. In particular, in one embodiment, the upstream-facing surfaces 640 and downstream-facing surfaces 642 can be substantially flat, planar surfaces of the one or more tabs 600. In other embodiments, all or a portion of the upstream-facing surfaces 640 and downstream-facing surfaces 642 of the one or more tabs 600 can include contoured, arcuate and/or angled planar surfaces.

However, whereas the tabs 100 of the debris removal system 54 can be configured, in one embodiment, to extend radially outward from the downstream end 110 of the debris conduit 102 into the surrounding interior flow volume 130 of the debris removal section 122 of the exhaust conduit 78, the one or more tabs 600 of the present compartment cooling system 56 can be positioned to extend radially inward from the downstream end 86 of the exhaust conduit 78 toward the central axis 228 and interior flow volume 227 of the downstream end section 226. In particular, each upstream-facing surface 640 can be positioned, oriented, or otherwise disposed within the compartment cooling system 56 proximate to the downstream end 86 of the exhaust conduit 78 and generally facing the interior flow volume 227 of the downstream end section 226 to engage the third gas flow 138 fluidly directed out of the downstream end 86 of the exhaust conduit 78 over and/or in fluid contact with one or more, or a plurality of boundary surfaces 646. Each downstream-facing surface 642 can be positioned, oriented, or otherwise disposed within the within the compartment cooling system 56 proximate to the downstream end 86 of the exhaust conduit 78 and generally facing the interior flow volume 210 and oriented toward the downstream end 216 thereof of the gas outlet conduit 204 to engage and/or fluidly direct the second gas flow 200 drawn, induced, or otherwise fluidly communicated from the interior 38 of the compartment 36 over and/or in fluid contact with one or more, or a plurality of boundary surfaces 646. The boundary surfaces 646 can include free, or un-attached outer or peripheral surfaces of and/or between the opposing upstream-facing surface 640 and downstream-facing surface 642, and in one embodiment, can define at least a portion of the outer profile or shape of each tab 600 as well as the upstream-facing surfaces 640 and downstream-facing surfaces 642 thereof, and can include a pair of lateral edges 648, at least one outer edge 650, and any one or more or a combination of corners, tips, and/or projections, as further provided herein. The base surface 644 of each tab 600 can be an interior, adjacent, and/or attached surface from which the upstream-facing surfaces 640, downstream-facing surfaces 642, and boundary surfaces 646 can extend, as further provided herein.

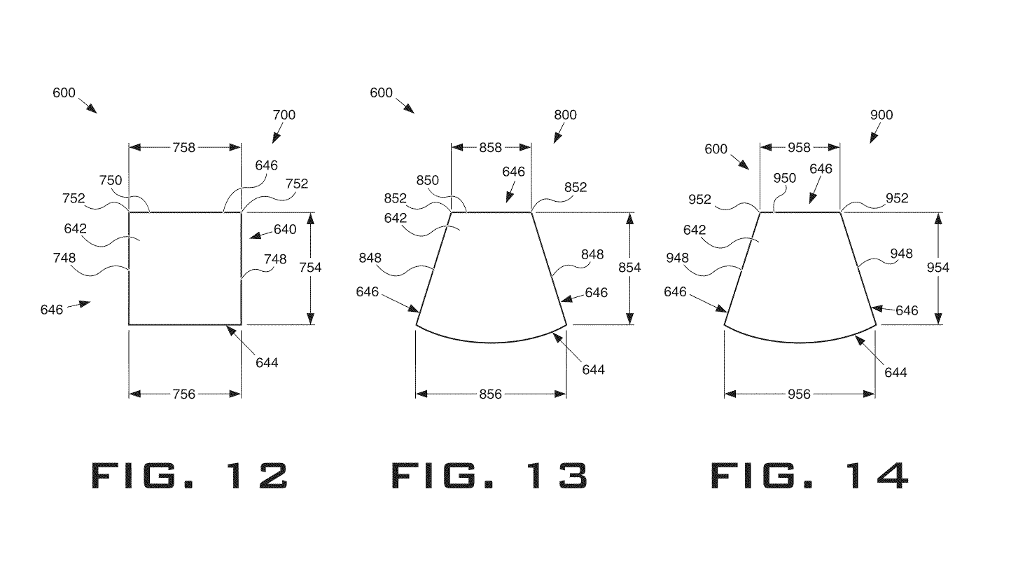

In addition, in one embodiment, the one or more tabs 600, and the upstream-facing surfaces 640 and downstream-facing surfaces 642 thereof, can both extend radially inwardly from the downstream end 86 of the exhaust conduit 78 toward the interior flow volume 227 and central axis 228 of the downstream end section 226, and additionally can be angled to extend axially outward from the downstream end 86 of the exhaust conduit 78 toward the downstream end 216 of the gas outlet conduit 204 and, in one embodiment, may extend into the interior flow volume 210 thereof at an angle 235 with respect to the central axis 228 of the downstream end section 226 of the exhaust conduit 78 and/or the central axis 224 of the gas outlet conduit 204. In particular, the lateral edges 648 and the upstream facing surfaces 640 and downstream facing surfaces 642 of each tab 600 can extend radially inwardly and can be angled axially outward, as provided above, from the base surface 644 which can be attached to, formed from, or otherwise positioned adjacent to the downstream end 86 of the exhaust conduit 78, to connect with one or more outer edges 650 extending therebetween. In one embodiment, each tab 600 can be angled to extend radially inwardly from the downstream end 86 of the exhaust conduit 78 and axially outwardly toward the downstream end 216 of the gas outlet conduit 204 as provided above at an angle 235 of between twenty and eighty degrees (30°-60°). In another example, each tab 600 can be angled to extend radially inwardly from the downstream end 86 of the exhaust conduit 78 consistent with the foregoing at an angle 235 of between twenty and eighty degrees (40°-50°). The one or more tabs 600 can also include a plurality of different shapes, profiles, and/or features. In particular, in the exemplary embodiment shown in FIG. 12, the tab 600 can be embodied as a substantially square or rectangular tab 700 and can include a pair of lateral edges 748 which extend outward from the base surface 644 to connect with an outer edge 750 to form a pair of corners 752 and define the length 754 of the upstream facing surface 640 and downstream facing surface 642 as well as that of the tab 300, wherein the base width 756 and outer width 758 of the corresponding surfaces and the tab 700 can be substantially equivalent to define the upstream facing surface 640 and the downstream facing surface 642 and the tab 700 as substantially square or rectangular. In another example of an exemplary tab 600 as shown in FIG. 13, a trapezoidal tab 800, and the upstream facing surface 640 and downstream facing surface 642 thereof, can include an outer edge 850 having an outer width 858 which is shorter than a base width 856 of the base surface 644, and can include a pair of tapered lateral edges 848 which extend inwardly at substantially equivalent angles from the base surface 644 to connect with the outer edge 850 and form corners 852 therewith and define the length 854 of the trapezoidal tab 800.

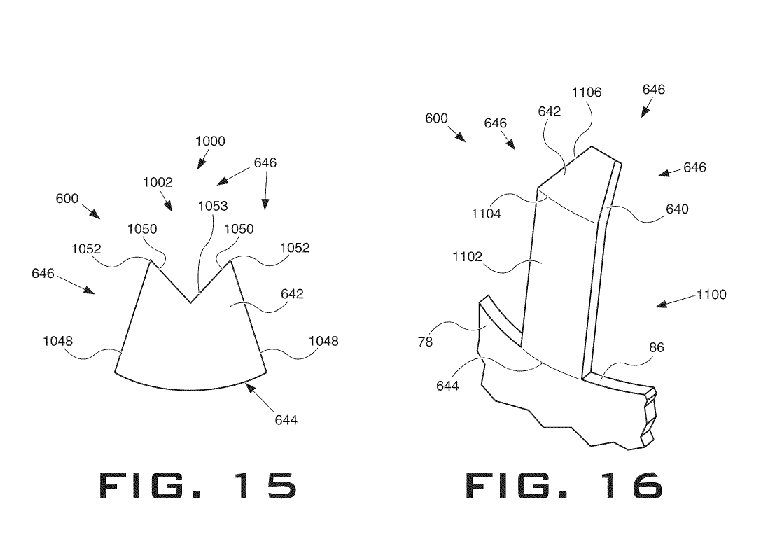

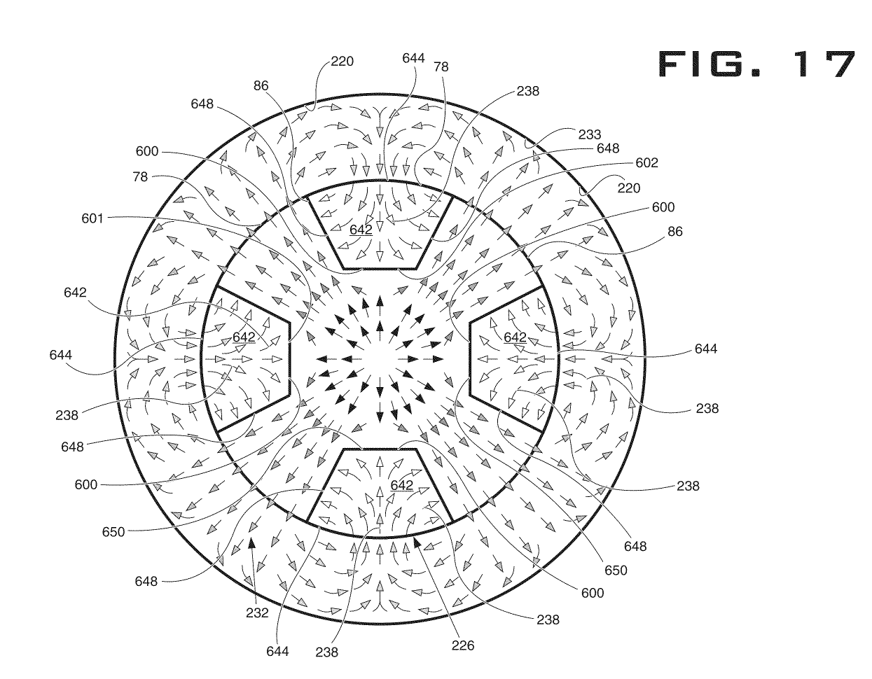

FIG. 14 illustrates another embodiment of an elongated trapezoidal tab 900 including an outer edge 950 with corners 952 and an outer width 958 which is shorter than a base width 956 of the base surface 644 and additionally includes tapered lateral edges 948 which extend along an elongated length 954, which can in one example, can be between one and a half to twice as long as the base width 956. FIG. 15 illustrates another embodiment of an exemplary tab 600 embodied as a sawtooth tab 1000 including a sawtooth edge profile 1002. The sawtooth tab 1000 can include lateral edges 1048, which can be tapered inwardly at substantially equivalent angles, which can extend from the base surface 644 to connect with and form outer tips 1052 of the sawtooth edge profile 1002 of the upstream facing surface 640 and downstream facing surface 642, which can include a pair of angled outer edges 1050 which can extend between the outer tips 1052 to form an angled interior corner 1053 therebetween. In another example of an exemplary tab 600 as shown in FIG. 16, an elongated, angled tab 1100 can include an extension 1102 which can extend axially outward from the base surface 644 and the downstream end 86 of the exhaust conduit 78 toward the downstream end 216 of the gas outlet conduit 204 to an outer edge 1104 and can be aligned and/or coplanar with the exhaust conduit wall 88. At the outer edge 1104 of the extension 1102 opposite the base surface 644, the elongated, angled tab 1100 can include an angled outer tab end 1106, which can extend from the outer edge of the extension (which can be via a bend) radially inwardly toward the interior flow volume 227 and central axis 228 of the downstream end section 226 and can be angled axially outward toward the downstream end 216 of the gas outlet conduit 204. The angled outer tab end 1106 as illustrated in FIG. 16 can be formed to include the trapezoidal tab 800, and features thereof as illustrated in FIG. 13. However, the angled outer tab end can alternatively include any one of the foregoing tabs, including but not limited to the substantially square or rectangular tab 700 or the sawtooth tab 1000.

The base surface 644 of each tab 600 can be positioned and/or attached by any suitable means adjacent to the downstream end 86 of the exhaust conduit 78. The tabs 600, and the base surfaces 644 thereof, may each individually or together as a combined unit be fixedly attached to the exhaust conduit 78 through welding, adhesive, clamps, snap rings, bolts, or any other suitable means. Alternatively, the base surfaces 644 of the tabs 600 may be formed integral to the exhaust conduit 78. It is also contemplated that in some embodiments, the tabs 600 may be fixedly attached to another component(s) different than the exhaust conduit 78, and held stationary against the exhaust conduit 78, such that the base surfaces 644 are adjacent the downstream end 86 of the exhaust conduit 78.

In the illustrated exemplary embodiments shown in FIGS. 11 & 17, four tabs 600 are circumferentially and substantially evenly spaced to extend from the downstream end 86 of the exhaust conduit 78 as provided above. In particular, the exemplary embodiments shown in FIGS. 11 & 17 illustrate four sawtooth tabs 1000 evenly spaced around the outer circumference of the downstream end 86 of the exhaust conduit 78. However, the downstream end 86 of the exhaust conduit 78 can alternatively include any of the foregoing disclosed tabs, including the substantially square or rectangular tab 700, the trapezoidal tab 800, the elongated trapezoidal tab 900, or the elongated, angled tab 1100, as provided above. In another embodiment, only two tabs, such as first tab 601 and second tab 602 as shown in the exemplary embodiment of FIG. X are included and are positioned to extend from the downstream end 86 of the exhaust conduit 78. In one example both of the first tab 601 and the second tab 602 can extend from and can be commonly attached to a single half of the outer circumference and diameter of the downstream end 86 of the exhaust conduit 78 such that the first tab 601 and the second tab 602 may be positioned to align with, engage and account for a variant flow path and/or flow distribution of the third gas flow 138 which may be based upon the shape and/or curvature of the interior flow volume 84 of the exhaust conduit 78. However, without departing from the spirit and scope of the present disclosure, different numbers of tabs 600 may be evenly, or unevenly, spaced around and extending from the downstream end 86 of the exhaust conduit 78. In one example, the downstream end 86 of the exhaust conduit 78 can include between one and sixteen evenly or unevenly spaced tabs 600. In another example, the downstream end 86 of the exhaust conduit 78 can include between two and six evenly or unevenly spaced tabs 600. In the exemplary embodiments illustrated in FIGS. 11 & 17, each tab 600 is generally the same size and shape, and is angled at substantially the same angle 235. In alternative embodiments, one or more, or each of the tabs 600 may be different shapes and sizes, and may extend from the downstream end 86 of the exhaust conduit 78 at different angles.

As provided herein, the gas outlet conduit 204, the exhaust conduit 78, as well as the downstream end section 226 and one or more tabs 600 thereof, can be positioned, oriented, relatively sized and/or otherwise configured to form and maintain stable, sustained streamwise vortices 238, as discussed herein, within the mixing and vortex generation zone 233 and maintain a substantially consistent flow ratio between the third gas flow 138 fluidly directed through and out of the downstream end 86 of the interior flow volume 227 of the downstream end section 226 of the exhaust conduit 78 and the second gas flow 200 fluidly drawn into and circulated through the compartment 36 and drawn into the gas outlet conduit 204 proximate to the downstream end 86 of the exhaust conduit 78 over a wide range of flow rates such that flow separation, peak velocity, and flow resistance, as well as flow/fluid noise, may be reduced or substantially eliminated. In addition to the foregoing, as provided above, the downstream end 86 of the exhaust conduit 78 and the downstream end section 226 thereof, can be positioned at or substantially aligned with the upstream end 214 of the gas outlet 48, which in one embodiment, can be defined or formed by opening 220, or alternatively can extend into and through the opening 220 at the upstream end 214 of the gas outlet conduit 204 and can be partially positioned within the interior flow volume 210 gas outlet conduit 204 at any one of a plurality of positions along an axial length 230 which extends from the upstream end 214 of the gas outlet 48 into the interior flow volume 210 and hollow interior 208 of the gas outlet conduit 204. In one embodiment, the relative position or “insertion” at which the downstream end 86 of the exhaust conduit 78 aligns with or extends into the interior flow volume 210 gas outlet conduit 204 can be measured or defined as a ratio with reference to the diameter 231 of the downstream end section 226 of the exhaust conduit 78. In particular, in one embodiment, the position or “insertion” of the downstream end 86 of the exhaust conduit 78 at or into the upstream end 214 of the gas outlet 48 and the interior flow volume 210 gas outlet conduit 204 along the axial insertion length 230 can be defined as a distance measuring between 0% and 30% of the diameter 231 of the downstream end section 226 of the exhaust conduit 78, and in one example can be between 0% and 15% of the diameter 231 of the downstream end section 226 of the exhaust conduit 78, wherein 0% insertion (length 230/diameter 231) is defined as a position wherein the downstream end 86 of the exhaust conduit 78 is linearly aligned with the upstream end 214 of the gas outlet 48 with the entirety of the downstream end section 226 of the exhaust conduit 78 outside and upstream of the upstream end 214 of the gas outlet. Additionally, in one embodiment, the relative size and/or proportion between the downstream end section 226 of the exhaust conduit 78 and the gas outlet conduit 204 can be measured or defined as the ratio between the diameter 231 of the downstream end section 226 of the exhaust conduit 78 and the diameter 223 of the gas outlet conduit 204 and gas outlet conduit wall 205, (diameter 231/diameter 223) which can be between 20% and 30%, and in one example can be approximately 25%.

### INDUSTRIAL APPLICABILITY

The presently disclosed gas flow system 10, as well as any one or more of the systems, features, components, and functionalities thereof according to any one or more of the embodiments as disclosed herein can be implemented and utilized with any of a variety of machines which can incorporate and utilize a gas flow system 10 consistent with any one or more of the embodiments as disclosed herein. In addition to further advantages, the gas flow system 10 according to any one or more of the embodiments as disclosed herein may provide increased flow for more effective debris removal while reducing flow noise and improving sound qualities and characteristics of the flows within the system. The presently disclosed gas flow system 10 may also substantially reduce flow separation, flow fluctuations and inadvertent and/or irregular flow paths and flow reversals within the system and any adverse effects which may be attributable thereto. Furthermore, in addition to further advantages both as stated herein as well as those as understood by one of ordinary skill of the art upon being provided with the benefit of the teachings of the present disclosure, the gas flow system 10 of the present disclosure may consistently provide increased cooling airflow and circulation as well as stable, more complete, low velocity flow mixing and debris removal without an increased or adverse effect on or sensitivity to backpressure while reducing the costs and/or complexity including but not limited to those attendant to manufacturing.

In particular, the debris removal system 54 according to any one or more of the embodiments as disclosed herein may provide an effective and/or increased flow and particle transport velocity of the portion of the first gas flow 62 and debris 64 which may be entrained therein directed through the interior flow volume 108 of the debris conduit 102 over a wide range of primary gas flow 94 flow rates. Additionally, and as provided herein, the debris removal system 54, as well as the one or more components thereof may be configured to provide an effective and/or improved velocity, mixing and flow of the first gas flow, primary gas flow, and third gas flow 62, 94, 138 according to any one or more of the embodiments of the present disclosure without having an adverse impact, and in one example may compliment and/or cooperatively interact with the compartment cooling and circulation of airflow of the compartment cooling system 56.

As provided above, one or more tabs 100, and the upstream-facing surfaces 140 and downstream-facing surfaces 142 thereof can be connected or otherwise positioned to extend radially outwardly from the downstream end 110 and the radial periphery of the exterior surface 114 of the debris conduit 102 into the radial gap 134 within the interior flow volume 130 of the debris removal section 122 between the exterior surface 114 of the debris conduit wall 112 surrounding the downstream end 110 of the debris conduit 102 and the interior surface 92 or surfaces of the exhaust conduit wall 88 of the debris removal section 122. Additionally, each of the one or more tabs 100 can form an outer radial gap 152 within the interior flow volume 130 of the debris removal section 122 between the one or more outer edges 150 of each tab 100 and the interior surface 92 of the exhaust conduit wall 88 of the debris removal section 122.

With this configuration, and as shown in FIGS. 9 & 10, the primary gas flow 94 fluidly directed through the interior flow volume 130 of the debris removal section 122 of the exhaust conduit 78 may fluidly engage the upstream-facing surface 140 of each of the one or more tabs 100, which in one embodiment may be angled as provided above. As the primary gas flow 94 hits or fluidly engages each upstream facing surface 140, the primary gas flow 94 may create a high pressure zone at, near, and/or proximate to each upstream facing surface 140 and additionally may create a comparatively low pressure zone at, near, and/or proximate to each opposing downstream facing surface 142, and may create an area of reduced pressure within the mixing and vortex generation zone 136 proximate to, adjacent to and/or downstream of the downstream facing surfaces 142. The area of reduced pressure within the mixing and vortex generation zone 136 may create a pressure differential and may direct the primary gas flow 94 over the boundary surfaces 146. Additionally, each upstream facing surface 140 may push or urge the primary gas flow 94 radially outwardly towards the exhaust conduit wall 88 of the debris removal section 122 and may thereby accelerate the flow velocity of the primary gas flow 94 as it is directed over the side boundary surfaces 146 and the end boundary surfaces 146 including but not limited to the lateral edges 148 and the one or more outer edges 150, as well as any one or more corners (such as 352, 452, 553) and/or tips (such as 552), respectively, of each tab 100. As the primary gas flow 94 may be accelerated and/or may otherwise be directed over the boundary surfaces 146 at least in part, by the pressure differential as provided above, the primary gas flow 94 may generate a plurality of streamwise vortices 236 having rotating axes substantially parallel to the central axis 132 of the debris removal section 122 and/or the central axis 120 of the downstream end section 118 of the debris conduit 102 proximate to, adjacent to and/or downstream of the downstream facing surfaces 142 within the mixing and vortex generation zone 136. These streamwise vortices 236 formed by the primary gas flow 94 may fluidly draw, induce, or otherwise generate a plurality of radial cross flows 237 within the primary gas flow 94 which may fluidly direct the primary gas flow 94 within the radial gap 134 between circumferentially and/or laterally adjacent lateral edges 148 of the tabs 100 extending outward from the debris conduit wall 112 radially inwardly over the debris conduit wall 112 and across the downstream end 110 of the debris conduit 102 toward the center axis 132 of the debris removal section 122 of the exhaust conduit 78 within the mixing and vortex generation zone 136.

The plurality of streamwise vortices 236 and radial cross flows 237 which may be generated within the primary gas flow 94 across and/or adjacent to the downstream end 110 of the debris conduit 102 and the interior flow volume 108 thereof may draw, induce, facilitate, and/or otherwise cause a portion of the first gas flow 62 flowing through the first gas inlet 44 and into the debris collection area 72 of the pre-cleaner 66, as well as any debris 64 contained therein, to be directed into and through the hollow interior 104 of the debris conduit 102 along and throughout the interior flow volume 108 thereof. As the portion of the first gas flow 62 is fluidly directed out of the downstream end 110 of the debris conduit 102, the first gas flow 62 may fluidly engage the downstream facing surfaces 142 of the one or more tabs 100. The downstream facing surfaces 142 of the one or more tabs 100 may fluidly direct the portion of the first gas flow 62 from the downstream end 110 of the debris conduit 102 over one or more, or a plurality of boundary surfaces 146, including but not limited to the lateral edges 148 and the one or more outer edges 150 as well as any one or more corners (such as 352, 452, 553) and/or tips (such as 552) of each tab 100, to fluidly interact with the primary gas flow 94 to further form streamwise vortices 236 between the first gas flow 62 and the primary gas flow 94 proximate to, adjacent to and/or downstream of the downstream facing surfaces 142 and/or the downstream end 110 of the debris conduit 102 within and throughout the mixing and vortex generation zone 136. In this manner, by virtue and/or operation of the tabs 100 as well as the configurations of the presently disclosed embodiments of the debris removal system 54, the third gas flow 138, which may be a combination, and in one example, a substantially even mixture of the primary gas flow 94 and the portion of the first gas flow 62, may be fluidly communicated from the mixing and vortex generation zone 136, to the downstream end 86 of the exhaust conduit 78.

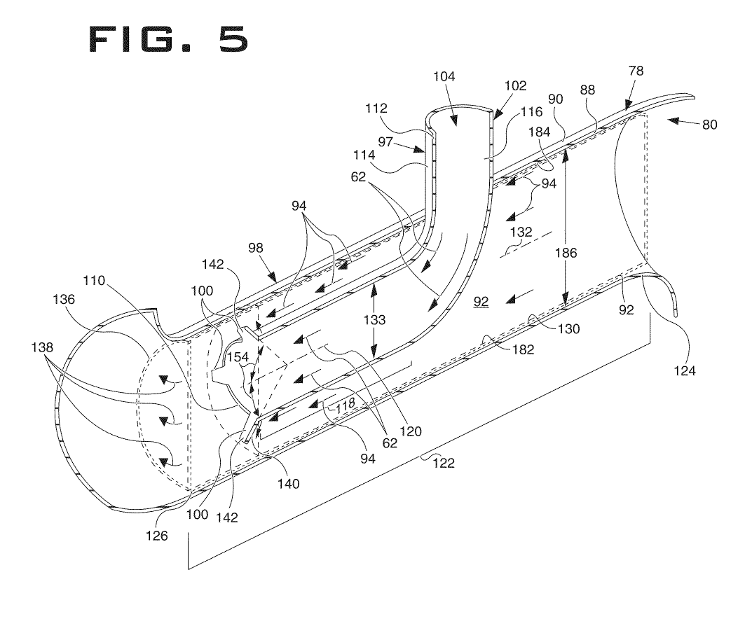

Additionally, the debris removal section 122 can be configured to controllably reduce and maintain a consistently reduced diameter and cross sectional flow area (such as second or downstream end diameter 170 and second cross sectional flow area 158 as shown in FIGS. 2, 4 & 9) or can be configured to maintain a consistent diameter and cross sectional flow area (such as diameter 186 and cross sectional flow area 182 as shown in FIGS. 3, 5 & 7) without providing a diffuser, an expanding internal flow volume, and/or a portion or section of the exhaust conduit wall 88 of the debris removal section 122 having a radially expanding diameter at and/or fluidly proximate to the downstream end 110 of the debris conduit 102 within the debris removal section 122. In addition, the debris removal section 122, the debris conduit 102, as well as the downstream end section 118 and one or more tabs 100 thereof, can be positioned, oriented, relatively sized and/or otherwise configured to provide a stable, consistent, effective and/or increased flow and particle transport velocity of the portion of the first gas flow 62 and debris 64 which may be entrained therein directed through the interior flow volume 108 of the debris conduit 102 over a wide range of flow rates, including lower peak velocities of the primary gas flow 94 directed through the interior flow volume 130 of the debris removal section 122. In particular, in one example, the debris removal section 122, the debris conduit 102, as well as the downstream end section 118 and one or more tabs 100 thereof, can be positioned, oriented, relatively sized and/or otherwise configured to generate and maintain stable, sustained streamwise vortices 236 and radial cross flows 237 as provided above within the mixing and vortex generation zone 136 of the debris removal section 122 and maintain a substantially consistent flow ratio between the first gas flow 62 fluidly directed through the debris conduit 102 and the primary gas flow 94 fluidly directed through the debris removal section 122 of the exhaust conduit 78 over a wide range of primary gas flow 94 flow rates such that flow separation, flow resistance, as well as flow noise, may be substantially reduced.

Specifically, in one example, the debris removal section 122, the debris conduit 102, as well as the downstream end section 118 and one or more tabs 100 thereof, can be positioned, oriented, relatively sized and/or otherwise configured according to any one or more of the embodiments as provided herein such that the flow ratio between the first gas flow 62 fluidly directed through the debris conduit 102 and the primary gas flow 94 fluidly directed through the debris removal section 122 of the exhaust conduit 78 (first gas flow 62 (kg/h)/primary gas flow 94 (kg/h)) may be maintained at a ratio of between 7% and 10% at fluid velocities or speeds of the primary gas flow 94 fluidly directed through the debris removal section 122 of the exhaust conduit 78 at and/or fluidly proximate to the downstream end 110 of the debris conduit 102 defined by a Mach number (M) as low as 0.5 or less, and in one example as low as between 0.3 and 0.5. The substantially consistent flow ratio between the portion of the first gas flow 62 through the interior flow volume 108 of the debris conduit 102 and the primary gas flow 94 fluidly directed through the debris removal section 122 of the exhaust conduit 78 as provided by the foregoing example over a wide range of primary gas flow 94 flow rates may be provided, at least in part, as a result of the improved mixing and the plurality of streamwise vortices 236, which may be provided by the one or more tabs, as discussed above. Furthermore, the improved mixing and the plurality of streamwise vortices 236 which may be created by the one or more tabs 100 in concert with one or more of the additional features of the debris removal system 54 consistent with any one or more of the embodiments as provided herein, may provide a stable, consistent, effective and/or increased flow and particle transport velocity of the portion of the first gas flow 62 through the interior flow volume 108 of the debris conduit 102 with a reduced primary gas flow 94 velocity. In turn, the lower reduced primary gas flow 94 velocity which may be required to generate an effective first gas flow 62 through the interior flow volume 108 of the debris conduit 102 may also increase the efficiency of the debris removal system 54 in addition to substantially reducing flow noise and engine 34 exhaust flow backpressure, which may reduce fuel consumption and increase fuel efficiency. Thus, as a result of the lower velocities of the primary gas flow 94 which may be directed through the interior flow volume 130 of the debris removal section 122 which may provide effective, or increased flow and debris 64 removal through the debris conduit 102, the presently disclosed debris removal system 54 may reduce engine 34 backpressure and further may fluidly and cooperatively interact with the fluidly downstream, exhaust conduit 78 downstream end section 226 and the compartment cooling system 56.

The compartment cooling system 56 according to any one or more of the embodiments as disclosed herein may provide an increased, more effective, consistent, and stable flow, fluid interaction and mixing between the third gas flow 138 and the second gas flow 200, which may provide increased flow and circulation of the second gas flow 200 into and through the interior 38 of the compartment 36. The one or more tabs 600, and the upstream-facing surfaces 640 and downstream-facing surfaces 642 thereof, can both extend radially inwardly from the downstream end 86 of the exhaust conduit 78 toward the interior flow volume 227 and central axis 228 of the downstream end section 226, and additionally can be angled to extend axially outward from the downstream end 86 of the exhaust conduit 78 toward the downstream end 216 of the gas outlet conduit 204 and, in one embodiment, may extend into the interior flow volume 210 thereof at an angle 235 with respect to the central axis 228 of the downstream end section 226 of the exhaust conduit 78 and/or the central axis 224 of the gas outlet conduit 204. As a result, each upstream-facing surface 640 can be positioned generally facing the interior flow volume 227 of the downstream end section 226 of the exhaust conduit 78 to engage the third gas flow 138 fluidly directed out of the downstream end 86 of the exhaust conduit 78 over and/or in fluid contact with one or more, or a plurality of boundary surfaces 646. Additionally, each downstream-facing surface 642 can be positioned generally facing the interior flow volume 210 and oriented toward the downstream end 216 thereof of the gas outlet conduit 204 to engage and/or fluidly direct the second gas flow 200 drawn, induced, or otherwise fluidly communicated from the interior 38 of the compartment 36 over and/or in fluid contact with one or more, or a plurality of boundary surfaces 646.

With this configuration, the third gas flow 138 fluidly directed out of the downstream end 86 of the interior flow volume 227 of the downstream end section 226 of the exhaust conduit 78 may fluidly engage the upstream-facing surface 640 of each of the one or more tabs, which may be angled to extend radially inwardly into the interior flow volume 227 of the downstream end section 226, and axially outwardly toward the downstream end 216 of the gas outlet conduit 204 as provided above. As the third gas flow 138 engages each upstream-facing surface 640, each upstream-facing surface 640 may urge the third gas flow 138 radially inwardly with respect to the central axis 228 of the downstream end section 226 as well as the unimpeded third gas flow 138 directed out of the central portion of the interior flow volume 227 of the downstream end section 226 of the exhaust conduit 78 and may thereby accelerate the flow velocity of the third gas flow 138 as it is directed over the side boundary surfaces 646 and the end boundary surfaces 646 including but not limited to the lateral edges 648 and the one or more outer edges 650, as well as any one or more corners (such as 752, 852, 952, 1053) and/or tips (such as 1052), respectively, (as well as any one or more of the foregoing boundary surfaces 646 of the angled outer tab end 1106) of each tab 600. As the third gas flow 138 may be accelerated over the boundary surfaces 646, the third gas flow 138 may form a plurality of streamwise vortices 238, as shown in FIG. 17, having rotating axes substantially parallel to the central axis 228 of the downstream end section 226 of the exhaust conduit 78 and/or the central axis 224 of the gas outlet conduit 204 proximate to, adjacent to and/or downstream of the downstream facing surfaces 642 within the mixing and vortex generation zone 233. These streamwise vortices 238 formed by the third gas flow 138 may create an area of reduced pressure within the mixing and vortex generation zone 233 proximate to, adjacent to and/or downstream of the downstream facing surfaces 642, which in one embodiment can be at, proximate to, or otherwise fluidly proximate to the upstream end 214 of the gas outlet 48, and the opening 220 thereof, and in one example can be partially or completely within the hollow interior 208 of the gas outlet conduit 204 downstream of the upstream end 214 thereof. The area of reduced pressure within the mixing and vortex generation zone 233 may create a pressure differential or vacuum within the interior 38 of the compartment 36, and may fluidly draw, induce, or otherwise fluidly communicate and circulate the second gas flow 200 into and through the interior 38 of the compartment 36 (which may be via aperture 202) and subsequently into and through the opening 220 via the radial gap 232, and in some embodiments, between the exterior surface 90 of the exhaust conduit wall 88 of the downstream end section 226 of the exhaust conduit 78 and the interior surface 207 of the gas outlet conduit 204 and into the interior flow volume 210 of the gas outlet conduit 204 proximate to the downstream end 86 of the exhaust conduit 78 to fluidly engage the downstream facing surfaces 642 of the one or more tabs 600. The downstream facing surfaces 642 of the one or more tabs 600 may fluidly direct the second gas flow 200 over or in fluidly engaging contact with one or more, or a plurality of boundary surfaces 646, including but not limited to the side boundary surfaces 646 and the end boundary surfaces 646 including but not limited to the lateral edges 648 and the one or more outer edges 650, as well as any one or more corners (such as 752, 852, 952, 1053) and/or tips (such as 1052), respectively, (as well as any one or more of the foregoing boundary surfaces 646 of the angled outer tab end 1106) of each tab 600, to fluidly interact with the third gas flow 138 to further form streamwise vortices 238 between the third gas flow 138 and the second gas flow 200 within and throughout the mixing and vortex generation zone 233. In this manner, by virtue and/or operation of the tabs 600 as well as the configurations of the presently disclosed embodiments of the compartment cooling system 56, the fourth gas flow 234, which may be a combination, and in one example, a substantially even mixture of the third gas flow 138 and the second gas flow 200, may be fluidly communicated from the mixing and vortex generation zone 233 through the interior flow volume 210 of the gas outlet conduit 204 and to the air surrounding the outer surface 42 of the machine 12.

As provided herein, the gas outlet conduit 204, the exhaust conduit 78, as well as the downstream end section 226 and one or more tabs 600 thereof, can be positioned, oriented, relatively sized and/or otherwise configured to form and maintain stable, sustained streamwise vortices 238, as discussed herein, within the mixing and vortex generation zone 233 and maintain a substantially consistent flow ratio between the second gas flow 200 fluidly drawn into and circulated through the compartment 36 and drawn into the gas outlet conduit 204 proximate to the downstream end 86 of the exhaust conduit 78 and the third gas flow 138 which can include the primary gas flow 94 over a wide range of primary gas flow 94 flow rates, such that flow separation, peak primary gas velocity, and flow resistance, as well as flow noise, may be substantially reduced.

Specifically, in one example, the gas outlet conduit 204, the exhaust conduit 78, as well as the downstream end section 226 and one or more tabs 600 thereof, can be positioned, oriented, relatively sized and/or otherwise configured according to any one or more of the embodiments as provided herein such that the flow ratio between the second gas flow 200 fluidly drawn into and circulated through the compartment 36 and drawn into the gas outlet conduit 204 proximate to the downstream end 86 of the exhaust conduit 78 and the flow of the third gas flow 138 which can include the primary gas flow 94 (third gas flow 138 (kg/h)/second gas flow 200 (kg/h)) may be maintained at a ratio of between 90% and 100% at fluid velocities or speeds of the third gas flow 138 and/or primary gas flow 94 included therein defined by a Mach number (M) as low as 0.5 or less, and in one example between 0.3 and 0.5.

It will be apparent to those skilled in the art that various modifications and variations can be made to the system of the present disclosure without departing from the scope of the disclosure. Other embodiments will be apparent to those skilled in the art from consideration of the specification and practice of the system disclosed herein. It is intended that the specification and examples be considered as exemplary only, with a true scope of the disclosure being indicated by the following claims and their equivalent.

What is claimed is:

1. A gas flow system for a machine, comprising:
an air filtration system including a debris chamber;
a first conduit, a second conduit, and one or more tabs;
the first conduit extending from an upstream end to a downstream end;
the upstream end of the first conduit connected in fluid communication with the debris chamber;
the downstream end of the first conduit positioned within the second conduit;
the one or more tabs positioned within the second conduit adjacent to the downstream end of the first conduit; and
the second conduit including one or more of a decreasing diameter and a substantially consistent diameter adjacent to and downstream of the downstream end of the first conduit.

2. The gas flow system of claim 1 wherein the second conduit includes a debris removal section, the debris removal section including a hollow interior, the hollow interior of the debris removal section extending from an upstream end of the debris removal section to a downstream end of the debris removal section, and wherein the downstream end of the first conduit is positioned within the hollow interior of the debris removal section.

3. The gas flow system of claim 2 wherein the downstream end of the first conduit is facing the downstream end of the debris removal section of the second conduit.

4. The gas flow system of claim 3 wherein the upstream end of the debris removal section of the second conduit includes a first cross sectional flow area, and the downstream end of the debris removal section includes a second cross sectional flow area, and wherein the second cross sectional flow area of the downstream end of the debris removal section is smaller than the first cross sectional flow area of the upstream end of the debris removal section of the second conduit.

5. The gas flow system of claim 4 wherein the debris removal section of the second conduit includes a flow area reducing section, and wherein the first cross sectional flow area of the debris removal section of the second conduit extends from the upstream end of the debris removal section to an upstream end of the flow area reducing section, and the second cross sectional flow area extends from a downstream end of the flow area reducing section to the downstream end of the debris removal section of the second conduit.

6. The gas flow system of claim 5 wherein the downstream end of the first conduit is positioned within the hollow interior of the debris removal section downstream of the upstream end of the flow area reducing section.

7. The gas flow system of claim 3 wherein the debris removal section of the second conduit includes a substantially constant cross sectional flow area extending from the upstream end of the debris removal section to the downstream end of the debris removal section of the debris conduit.

8. The gas flow system of claim 3 wherein the second conduit is configured to direct a primary gas flow through the hollow interior of the second conduit, and the one or more tabs are configured to fluidly engage the primary gas flow such that a first gas flow is fluidly communicated from the debris chamber into the first conduit.

9. The gas flow system of claim 8 wherein the one or more tabs each include a plurality of outer boundary surfaces within the hollow interior of the debris removal section, and wherein the one or more tabs are configured to direct at least one of the primary gas flow and the first gas flow over one or more of the plurality of boundary surfaces such that a plurality of streamwise vortices are generated within at least one of the primary gas flow and the first gas flow within a mixing and vortex generation zone within the hollow interior of the second conduit downstream of the downstream end of the first conduit.

10. The gas flow system of claim 9 wherein the one or more tabs are configured to maintain a substantially consistent flow ratio between the first gas flow fluidly directed through the first conduit and the primary gas flow fluidly directed through the second conduit over a range of primary gas flow flow rates, including a flow ratio between the first gas flow fluidly directed through the first conduit and the primary gas flow fluidly directed through the second conduit of between 7% and 10% at fluid velocities of the primary gas flow fluidly directed through the second conduit including a Mach number (M) of 0.5 or less.

11. The gas flow system of claim 10 wherein each of the one or more tabs are trapezoidal tabs.

12. The gas flow system of claim 10 wherein the outer boundary surfaces of each of the one or more tabs include angled edges which extend outward from a base surface, wherein the angled edges connect to form one or more tips and one or more corners.

13. A gas flow system for a machine, comprising:
a substantially enclosed compartment including a hollow interior;
a gas inlet connected in fluid communication with the hollow interior of the compartment;
a gas outlet including a hollow interior, the hollow interior of the gas outlet extending from an upstream end to a downstream end of the gas outlet;
the upstream end of the gas outlet including an opening, the opening fluidly connecting the hollow interior of the compartment with the hollow interior of the gas outlet;
a conduit extending from an upstream end to a downstream end, the downstream end of the conduit positioned in fluid communication with the hollow interior of the compartment and the hollow interior of the gas outlet;
one or more tabs positioned adjacent to the downstream end of the conduit and in fluid communication with the interior of the compartment and the interior of the gas outlet; and
the downstream end of the conduit positioned at one of a plurality of positions along an axial length which extends from the upstream end of the gas outlet into the hollow interior of the gas outlet.

14. The gas flow system claim 13 wherein the conduit includes a diameter, and the downstream end of the conduit extends into the hollow interior of the gas outlet at an axial length which is between 0% and 30% of the diameter of the of the conduit.

15. The gas flow system claim 13 wherein each of the one or more tabs include angled edges which extend outward from a base surface, wherein the angled edges connect to form one or more tips and one or more corners.

16. The gas flow system claim 13 wherein each of the one or more tabs are elongated trapezoidal tabs.

17. The gas flow system claim 13 wherein each of the one or more tabs include an extension which extends outward from the downstream end of the conduit to an angled outer tab end.

18. A gas flow system for a machine, comprising:
an air filtration system including a debris chamber;
an exhaust system including an exhaust conduit extending from an upstream end to a downstream end;
a debris removal system including a debris conduit, the exhaust conduit, and one or more tabs;
a compartment cooling system including a substantially enclosed compartment including a hollow interior, a gas inlet connected in fluid communication with the hollow interior of the compartment, a gas outlet, the exhaust conduit, and one or more tabs;
the debris conduit extending from an upstream end to a downstream end, the upstream end of the debris conduit connected in fluid communication with the debris chamber, and the downstream end of the debris conduit positioned within the exhaust conduit;
the one or more tabs of the debris removal system positioned within the exhaust conduit adjacent to the downstream end of the debris conduit;
the gas outlet including a hollow interior, the hollow interior of the gas outlet extending from an upstream end to a downstream end of the gas outlet, the upstream end of the gas outlet including an opening fluidly connecting the hollow interior of the compartment with the hollow interior of the gas outlet;
the downstream end of the exhaust conduit positioned in fluid communication with the hollow interior of the compartment and the hollow interior of the gas outlet; and
the one or more tabs of the compartment cooling system positioned adjacent to the downstream end of the exhaust conduit and in fluid communication with the interior of the compartment and the interior of the gas outlet.

19. The gas flow system claim 18 wherein the exhaust conduit includes one or more of a decreasing diameter and a substantially consistent diameter adjacent to and downstream of the downstream end of the debris conduit.

20. The gas flow system claim 18 wherein the one or more tabs of the debris removal system include at least one of trapezoidal tabs and angled edges which extend outward from a base surface and connect to form one or more tips and one or more corners, and the one or more tabs of the compartment cooling system include at least one of trapezoidal tabs, elongated trapezoidal tabs, angled edges which extend outward from a base surface and connect to form one or more tips and one or more corners, and an extension which extends outward from the downstream end of the conduit to an angled outer tab end.
